(19) United States
(12) Patent Application Publication
(10) Pub. No.: US 2025/0307825 A1
(43) Pub. Date: Oct. 2, 2025

(54) REAL-TIME DOCUMENT IMAGE EVALUATION

(71) Applicant: Capital One Services, LLC, McLean, VA (US)

(72) Inventors: Shena YOSHIDA, Brooklyn, NY (US); Namfon THASANON, Jersey City, NJ (US); Amith Kumar RAMACHANDRAN, Brunswick, NJ (US)

(73) Assignee: Capital One Services, LLC, McLean, VA (US)

(21) Appl. No.: 18/621,948

(22) Filed: Mar. 29, 2024

(51) Int. Cl. G06Q 20/40; G06Q 20/04; G06Q 20/10; G06Q 20/32; G06Q 40/02; G06T 7/00; G06V 30/10

(52) U.S. Cl. CPC G06Q 20/4016; G06Q 20/042; G06Q 20/108; G06Q 20/3223; G06Q 40/02; G06T 7/0002; G06V 30/10; G06T 2207/30176

(57) ABSTRACT

Disclosed herein are system, apparatus, device, method and/or computer program product embodiments for determining, in a remote deposit system, whether a deposit attempt is illegitimate (e.g. fraudulent). Whether the deposit attempt is illegitimate may be assessed based on one or more of the following processes: comparing location data to a location parameter determined from past deposits, comparing an image capture location with a deposit location, and analyzing image-of-image characteristics obtained through image processing to identify whether an image associated with the deposit attempt is an image of an image. In some embodiments, a remote deposit status related to acceptance of the deposit attempt may be provided in real-time

[symbol]

### COPYRIGHT AUTHORIZATION

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### BACKGROUND

As technology evolves, institutions have found ways to make digital document verification more convenient. For example, in the financial industry, mobile banking applications may let customers deposit paper checks from virtually anywhere using their smartphone or tablet to take and submit an image of a paper check for processing. In the financial or other industries, digital document verification may be required to verify a remote user's identity to provide access to services, goods, or funds.

Digital document verification may require solutions to various technical problems. For example, it can be difficult to verify that a document depicted in a digital image is not fraudulent. A remote user may attempt to provide a fraudulent document using a variety of methods, including creating/printing a physical document that is fraudulent and taking an image of the physical document, taking a picture of an image displayed on an electronic screen and providing the image of the electronic image, and/or by digitally creating/obtaining an image of a document and providing the digitally created image directly. In any of these cases, it may be difficult for a system receiving an image of a document to identify that the document in the image is fraudulent. This may be because no physical document may be available for an individual to inspect. It may be more difficult for computer systems to identify certain features, for example, unusual thickness, pliability, or presence or lack of edge features (e.g., serrations from a tear line), that would indicate a document is fraudulent. Further, computer systems that rely on an image of a document (e.g., a check) to complete remote deposits may not be able to verify that the MICR line of a check actually contains magnetic ink. Additionally, it may be difficult for computer systems to identify a fraudulent document when the document image is an image of an electronic or printed image, since the electronic or printed image may have been created from an image of a real document with certain features altered or may be an image of a real document with no features altered.

To perform digital document verification, it may be advantageous to track patterns and features of document images periodically provided by a remote user in order to verify whether future document images align with tracked patterns and features, and are therefore more likely to depict non-fraudulent documents. Though technically challenging, identifying images of documents that depart from established patterns and/or exhibit characteristics indicating that an image is an image of an image may be useful for detecting fraudulent images of documents such as checks, identification documents (e.g., passports, licenses, etc.), or any other document that is being digitally verified.

### BRIEF DESCRIPTION OF THE DRAWINGS

The accompanying drawings are incorporated herein and form a part of the specification.

FIG. 1 illustrates an example remote check capture, according to some embodiments.

FIG. 2 illustrates example remote deposit OCR segmentation, according to some embodiments.

FIG. 3 illustrates a block diagram of an example remote deposit system architecture, according to some embodiments.

FIG. 4 illustrates a flow diagram of an example remote deposit system, according to some embodiments.

FIG. 5 illustrates a block diagram of an example client computing device, according to some embodiments.

FIG. 6 illustrates a block diagram of an example deposit security system, according to some embodiments.

FIG. 7 illustrates a block diagram of an example check assessment system, according to some embodiments.

FIG. 8 illustrates example location parameters, according to some embodiments.

FIG. 9 illustrates a flow diagram of an example method, according to some embodiments.

FIG. 10 illustrates an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Disclosed herein are system, apparatus, device, method, and/or computer program product embodiments, and/or combinations and sub-combinations thereof, for assessing the security of a digitally provided document, in some cases based on image submission patterns associated with a customer. The system, apparatus, device, method, and/or computer program product embodiments, and/or combinations and sub-combinations thereof, may reliably identify digital images of documents that present a security concern.

The embodiments disclosed herein may be implemented in any context in which digital verification of documents is required. The embodiments disclosed herein may be implemented as part of a mobile check deposit process. Mobile check deposit is a fast, convenient way to deposit funds using a customer's mobile device. As financial technology and digital money management tools continue to evolve, the process has become safer and easier than ever before. Mobile check deposit is a way to deposit a paper check through a customer's mobile banking app using a smartphone or tablet. A mobile deposit allows the customer to capture a picture of the check using, for example, their smartphone or tablet camera and process it through a mobile banking application running on the mobile device. Deposits commonly include, but are not limited to, personal, business, or government checks.

Currently, computer-based (e.g., laptop) or mobile-based (e.g., mobile device) technology allows a customer to initiate a document uploading process for uploading images or other electronic versions of a document to a backend system (e.g., a document processing system) for various purposes, including remote check deposit. In some cases, once the image or other electronic version of a document (e.g., a check) is processed, the technology provides a remote deposit status indicating that processing has failed (e.g., due to security risks). In some cases, the remote deposit status may be provided to the customer only after a number of days, during which validation processes have been performed on the image (e.g., at a backend system).

This restrictive approach may be necessitated in certain document upload processes because such processes have automated routines for receiving the images, processing the images, and completing actions associated with the upload of the images. For example, a customer may utilize a mobile deposit application to upload a document associated with a customer account, such as a check associated with the customer's bank account. Once initiated, in existing systems, the document upload process may continue until the check image has been uploaded, processed, and has passed image quality and security checks. Information associated with the check image may be provided to model(s) that determine whether the check images pose a security concern. The model(s) may consider factors such as the amount of the deposit, stored payee customer data, including deposit history, stored payer data, etc. But in some cases the model(s) may not consider contextual data such as past deposit metadata patterns (e.g., image capture location, deposit location, and/or image-of-image characteristics). Accordingly, the model(s) may not identify when a check image poses a security concern by deviating from past deposit patterns, as the model(s) may operate according to automated routines that do not delve into deposit metadata associated with a customer to identify patterns and deviations therefrom.

Accordingly, current processes are problematic for two reasons: 1) They may not provide for real-time feedback on whether a deposit attempt poses a security concern and is rejected, forcing a customer to wait sometimes days to learn that a submitted deposit request is rejected; and 2) They may not provide security checks that perform adequate pattern analysis to identify suspicious deposit attempts.

Most banks and financial institutions use advanced security features to keep an account safe during the mobile check deposit workflow. For example, security measures may include encryption and device recognition technology. In addition, mobile check applications may capture the check deposit information without permanently storing the photos on the customer's mobile device (e.g., smartphone). Also, a thief of the check may not be allowed to subsequently make use of an already electronically deposited check, whether it has cleared or not, as remote deposit systems may provide an alert to the banking institution of a second deposit attempt. In addition, security controls may include mobile security alerts, such as mobile security notifications or SMS text alerts, which can assist in uncovering or preventing illegitimate (e.g., fraudulent) deposit activity.

Despite these security measures, a remote check deposit system may still be vulnerable to security breaches. For example, a customer may attempt to create a fraudulent check, either by creating a counterfeit physical check and taking an image of the physical check or by digitally creating/obtaining an image of a check and taking a photo of the image. In either case, it may be difficult for the remote check deposit system to identify that the check in the image is fraudulent. This may be because no physical check may be available for an individual (e.g., a teller) to inspect visually and by touch or scanning. It may be more difficult for computer systems to identify certain features, for example, unusual thickness, pliability, or presence or lack of edge features (e.g., serrations from a tear line), that would indicate a check is counterfeit. Further, computer systems that rely on an image of a check to complete remote deposits may not be able to verify that the MICR line of a check actually contains magnetic ink. Additionally, it may be difficult for computer systems to identify a fraudulent check when the check image is a digitally created image, since the image may have been created from an image of a real check with certain features altered or may be an image of a real check with no features altered.

The technology described herein in the various embodiments may determine, based on data on check deposit location patterns, and/or data on image-of-image characteristics obtained through image processing, when an image of a check corresponds to established legitimate (e.g., non-fraudulent) deposit activity patterns. Accordingly, the technology described herein in the various embodiments may identify, in some cases based on an image of a check deviating from established legitimate deposit activity patterns, images that pose a security risk (e.g. images of counterfeit checks, images of checks that do not belong to the customer, and/or images that evidence illegitimate control over a mobile banking application via “jailbreaking” or “rooting” of a phone). The technology described herein may identify image-of-image characteristics (i.e., characteristics that indicate an image is an image of a printed image or an image of a screen-displayed image) to identify when an image provided by a customer does not depict a real check. A customer may provide an image of an image in an effort to gain access to funds associated with a check depicted in an image (printed or on a screen) the customer is displaying in the field of view of a camera used to capture the image of the image. If an image is an image of a printed or screen-displayed image, this is a good indication the customer does not actually have access to the depicted check, and the deposit attempt is illegitimate (e.g., fraudulent).

In the various embodiments disclosed herein, Optical Character (OCR) may be used to extract data from a check image. OCR may be implemented locally on a mobile device or at a backend server. OCR is the electronic or mechanical conversion of images of typed, handwritten, or printed text into machine-encoded text, whether from a scanned document, a photo of a document, a scene photo, etc. Utilizing this capability, the OCR data (e.g., check issue date, check amount, signature, MICR line, account number, etc.) may be communicated to a check assessment model to compute a likelihood (e.g., a confidence score) that a check corresponds to legitimate deposit activity (and/or a likelihood that a check corresponds to illegitimate deposit activity). The likelihood may be used to determine a remote deposit status related to acceptance of a check image. In some embodiments, the remote deposit status may be provided to a mobile banking application and rendered on a user interface (UI). In such embodiments, a denial of remote deposit availability may be provided to the mobile banking application and rendered on the UI to deter an illegitimate (e.g., fraudulent) transaction. This can also make further processing of a check image at a backend system unnecessary.

In some embodiments, real-time Optical Character (OCR) may implement an OCR of check imagery locally on the mobile device or on cloud banking system 316 mid-experience instead of after submission of a check image, as described in U.S. patent application Ser. No. 18/509,748, filed Nov. 15, 2023 and titled “Deposit Availability Schedule,” the disclosure of which is incorporated by reference herein in its entirety. Utilizing this capability, the remote deposit status may be returned to the customer's mobile device in real-time, before or immediately after the customer has submitted a deposit request. Accordingly, the remote deposit status may be provided to the mobile banking application and rendered on the UI mid-experience, thus allowing the customer flexibility in depositing a check (e.g., the customer may decide and/or be forced to discontinue the remote deposit based on the remote deposit status). Rendering a remote deposit status on the UI mid-experience may save a customer time, preventing the customer from waiting, for example, a day or more, before receiving a denial of remote deposit availability when the customer could have attempted to deposit the check in person after receiving a remote deposit status indicating a denial of remote deposit availability in real time.

In some embodiments, the OCR process used to extract data from a check image may be implemented with an active OCR process. However, other known and future OCR applications may be substituted without departing from the scope of the technology disclosed herein. Active OCR is further described in U.S. application Ser. No. 18/503,778, entitled “Active OCR,” filed Nov. 7, 2023, and incorporated by reference in its entirety. Active OCR may perform OCR processing on image objects formed from a live stream of image data originating from an activated camera on a client device. The image objects may capture portions of a check or an entire image of the check. As a portion of a check image may be formed into a byte array, it may be provided to the active OCR system to extract any data fields found within the byte array in real-time or near real-time.

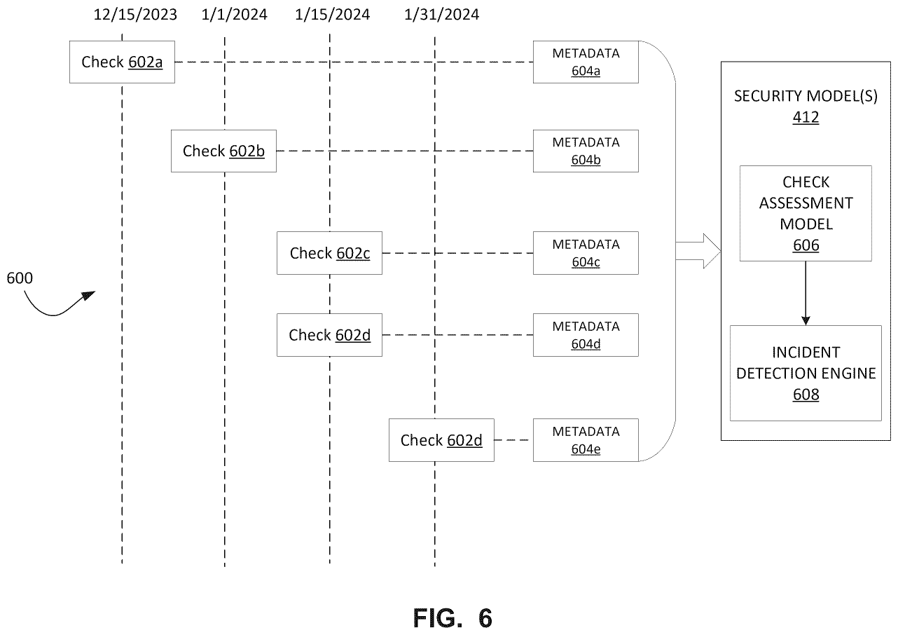

In the various embodiments disclosed herein, image processing may be performed to determine image-of-image characteristics. Image-of-image characteristics may include, but are not limited to, brightness, blue light levels, the presence or absence of a resolution feature, the presence or absence of a moiré pattern, and/or the presence or absence of one or more dot features and/or a dot feature pattern. Each of these are described herein in more detail. All or a subset of these image-of-image characteristics may be determined by an image processing system from an image of a check. Image-of-image characteristics determined from the image of the check may be compared to image-of-image characteristics determined for previously deposited checks and/or may be assessed in isolation. Based on the comparison and/or assessment, the remote deposit system disclosed herein may determine a likelihood that the check in the image is counterfeit (and/or a likelihood the check in the image is not-counterfeit). Like real-time OCR described above, in some embodiments, real-time image processing (e.g., augmented reality platform-based image processing as described with respect to FIG. 6) may be used to determine one or more image-of-image characteristics. In such embodiments, these one or more image-of-image characteristics may be compared to past image-of-image characteristics and/or assessed in real-time to assist in providing a customer with a remote deposit status mid-experience.

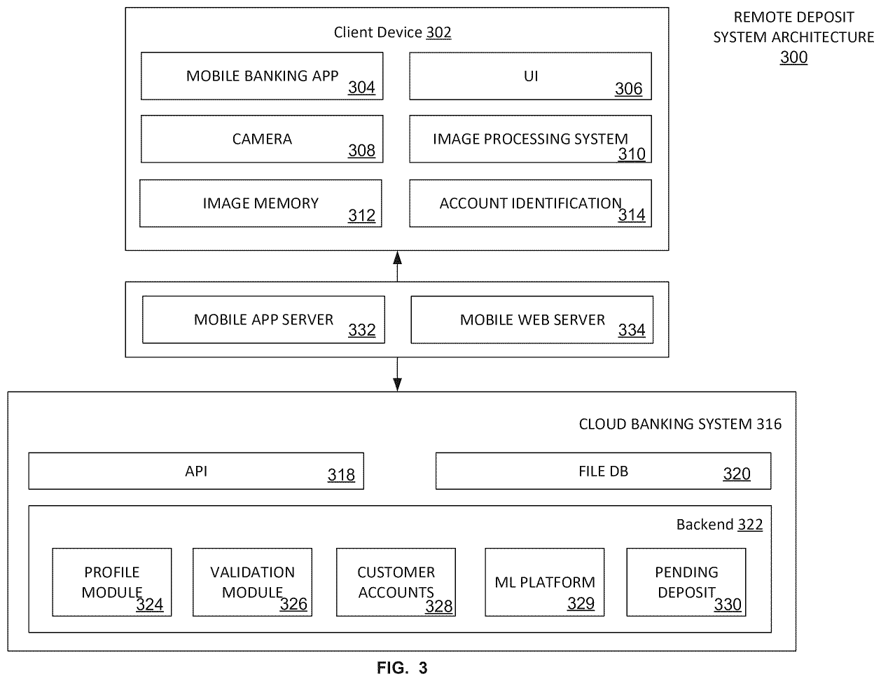

While the use of real-time OCR and other real-time image processing is described herein, image processing described herein may also be conducted after capture and transfer of an image or images to a cloud banking system (e.g., cloud banking system 316 described with respect to FIG. 3) or a third party platform.

Various embodiments of this disclosure may be implemented using and/or may be part of a remote deposit system shown in FIGS. 3-5. It is noted, however, that this environment is provided solely for illustrative purposes, and is not limiting. Embodiments of this disclosure may be implemented using and/or may be part of environments different from and/or in addition to the described remote deposit system, as will be appreciated by persons skilled in the relevant art(s) based on the teachings contained herein. For example, the machine learning (ML) aspects and processes described hereafter may be implemented locally on the customer's mobile device as part of or in addition to the mobile banking application. Alternatively, or in addition, ML model training may be performed remotely from the customer's mobile device, but a fully trained model may be implemented on the mobile device.

Machine learning involves computers discovering how they can perform tasks without being explicitly programmed to do so. Machine learning (ML) includes, but is not limited to, artificial intelligence, deep learning, fuzzy learning, supervised learning, unsupervised learning, etc. Machine learning algorithms build a model based on sample data, known as “training data,” in order to make predictions or decisions without being explicitly programmed to do so. For supervised learning, the computer is presented with example inputs and their desired outputs and the goal is to learn a general rule that maps inputs to outputs. In another example, for unsupervised learning, no labels are given to the learning algorithm, leaving it on its own to find structure in its input. Unsupervised learning can be a goal in itself (discovering hidden patterns in data) or a means towards an end (feature learning).

A machine-learning engine may use various classifiers to map concepts associated with a specific image submission process to capture relationships between concepts (e.g., deposit location vs. risk). The classifier (discriminator) is trained to distinguish (recognize) variations. Different variations may be classified to ensure no collapse of the classifier and so that variations can be distinguished.

Machine learning may involve computers learning from data provided so that they carry out certain tasks. For more advanced tasks, it can be challenging or impractical for a human to manually create the needed algorithms. This may be especially true of teaching approaches to correctly identify customer risk patterns and associated future risk. The discipline of machine learning therefore employs various approaches to teach computers to accomplish tasks where no fully satisfactory algorithm is available. In cases where vast numbers of potential answers exist, one approach, supervised learning, is to label some of the correct answers as valid. This may then be used as training data for the computer to improve the algorithm(s) it uses to determine correct answers.

In some embodiments, machine learning models may be trained with one customer's historical information and/or other customer's historical information (e.g., image capture location, deposit location, and/or image-of-image characteristics associated with previously submitted deposits of a single and/or other customers). In some embodiments, large training sets of the other customer's historical information may be used to normalize prediction data (e.g., not skewed by a single or few occurrences of a data artifact).

Variations of the devices disclosed herein are contemplated. For example, in a computing device with a camera, such as a smartphone or tablet, multiple cameras (each of which may have its own image sensor or which may share one or more image sensors) or camera lenses may be implemented to process imagery. For example, a smartphone may implement three cameras, each of which has a lens system and an image sensor. Each image sensor may be the same or the cameras may include different image sensors (e.g., every image sensor is 24 MP; the first camera has a 24 MP image sensor, the second camera has a 24 MP image sensor, and the third camera has a 12 MP image sensor; etc.). In the first camera, a first lens may be dedicated to imaging applications that can benefit from a longer focal length than standard lenses. For example, a telephoto lens generates a narrow field of view and a magnified image. In the second camera, a second lens may be dedicated to imaging applications that can benefit from wide images. For example, a wide lens may include a wider field-of-view to generate imagery with elongated features, while making closer objects appear larger. In the third camera, a third lens may be dedicated to imaging applications that can benefit from an ultra-wide field of view. For example, an ultra-wide lens may generate a field of view that includes a larger portion of an object or objects located within a user's environment. The individual lenses may work separately or in combination to provide a versatile image processing capability for the computing device. While described for three differing cameras or lenses, the number of cameras or lenses may vary, to include duplicate cameras or lenses, without departing from the scope of the technologies disclosed herein. In addition, the focal lengths of the lenses may be varied, the lenses may be grouped in any configuration, and they may be distributed along any surface, for example, a front surface and/or back surface of the computing device.

In one non-limiting example, active OCR processes may benefit from image object builds generated by one or more, or a combination of cameras or lenses. For example, multiple cameras or lenses may separately, or in combination, capture specific blocks of imagery for data fields located within a document that is present, at least in part, within the field of view of the cameras. In another example, multiple cameras or lenses may capture more light than a single camera or lens, resulting in better image quality. In another example, individual lenses, or a combination of lenses, may generate depth data for one or more objects located within a field of view of the camera.

An example of a remote deposit system shall now be described.

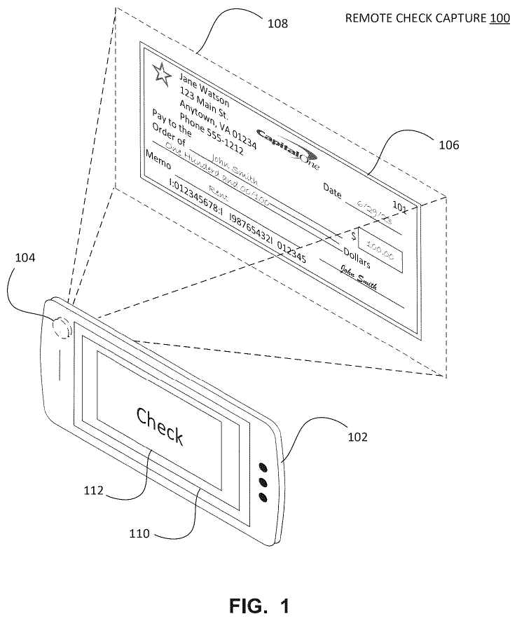

FIG. 1 illustrates an example remote check capture 100, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 1, as will be understood by a person of ordinary skill in the art.

Sample check 106 may be a personal check, paycheck, or government check, to name a few examples. In some embodiments, a customer will initiate a remote check capture from their mobile computing device (e.g., smartphone) 102, but other digital camera devices (e.g., tablet computer, personal digital assistant (PDA), desktop workstations, laptop or notebook computers, wearable computers, such as, but not limited to, Head Mounted Displays (HMDs), computer goggles, computer glasses, smartwatches, etc.) may be substituted without departing from the scope of the technology disclosed herein. For example, when the document to be deposit is a personal check, the customer may select a bank account (e.g., checking or savings) into which the funds specified by the check are to be deposited. Content associated with the document may include the funds or monetary amount to be deposited to the customer's account, the issuing bank, the routing number, and the payer's account number. Content associated with the customer's account may include a risk profile associated with the account and the current balance of the account. Options associated with a check deposit process may include continuing with the deposit process or cancelling the deposit process (and thereby cancelling depositing the check into the account).

Mobile computing device 102 may communicate with a bank or third party using a communication or network interface (not shown). The communication interface may communicate and interact with any combination of external devices, external networks, external entities, etc. For example, the communication interface may allow mobile computing device 102 to communicate with external or remote devices over a communications path, which may be wired and/or wireless (or a combination thereof), and which may include any combination of LANs, WANs, the Internet, etc. Control logic and/or data may be transmitted to and from mobile computing device 102 via a communication path that includes the Internet.

In an example approach, a customer may login to their mobile banking application, select the account they want to deposit a check into, then select, for example, a “deposit check” option that will activate their mobile device's camera 104. One skilled in the art would understand that variations of this approach or functionally equivalent alternative approaches may be substituted to initiate a mobile deposit.

Using the camera 104 function on the mobile computing device 102, the customer may capture an image of at least a portion of one side of a check 112. Typically, the camera's field of view 108 will include at least the perimeter of the check. However, any camera position that enables an in-focus electronic capture of the various data fields located on a check may be considered. The image capture can be achieved automatically or manually. Resolution, distance, alignment, and lighting parameters may require movement of the mobile device until a proper capture has been recorded. An application running on the mobile computer device may offer suggestions or technical assistance to complete a proper capture within the banking app's graphically displayed field of view window 110 displayed on a User Interface (UI) instantiated by the mobile banking app. A person skilled in the art of remote check image captures would be aware of common requirements and limitations and would understand that different approaches may be required based on the environment in which the check capture occurs. For example, poor lighting or reflections may require specific alternative techniques. As such, any known or future check capture techniques are considered to be within the scope of the technology described herein.

Sample customer instructions may include, but are not limited to, “Once you've completed filling out the check information and signed the back, it's time to take a picture of your check,” “For best results, place your check on a flat, dark-background surface to improve clarity,” “Make sure all four corners of the check fit within the on-screen frame to avoid any processing holdups,” “Select the camera icon in your mobile app to open the camera,” “Once you've taken a clear photo of the front of the check, repeat the process on the back of the check,” “Review the details of your check after uploading the images and ensure that the information is correct,” “Do you accept the funds availability schedule?” “Swipe the Slide to Deposit button to submit the deposit,” “Your deposit request may have gone through, but it's still a good idea to hold on to your check for a few days,” “Keep the check in a safe, secure place until you see the full amount deposited in your account,” and “After the deposit is confirmed, you can safely destroy the check.” These instructions are provided as sample instructions but may include any instructions that guide the customer through a remote deposit session.

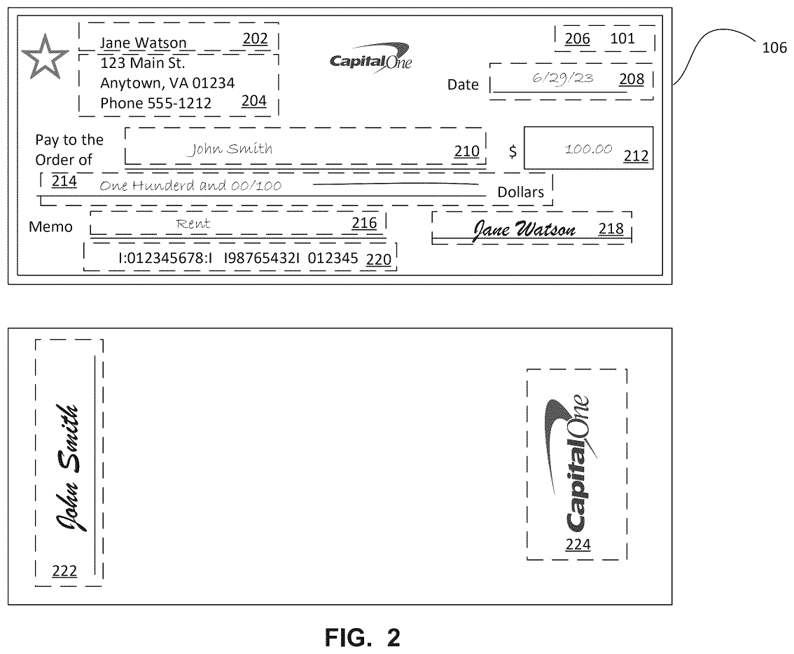

FIG. 2 illustrates example remote deposit OCR segmentation, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 2, as will be understood by a person of ordinary skill in the art.

Depending on check type, a check may have a fixed number of identifiable fields. For example, a standard personal check may have front side fields, such as, but not limited to, payer name 202 and address 204; check number 206; date 208; payee field 210; payment amount 212; a written amount 214; memo line 216; Magnetic Ink Character Recognition (MICR) line 220 that includes a string of characters including the payer's bank's routing number, the payer's account number, and the check number; and finally the customer's signature 218. Back side identifiable fields may include, but are not limited to, payee signature 222 and security fields 224, such as a watermark.

While a number of fields have been described, it is not intended to limit the technology disclosed herein to these specific fields as a check may have more or fewer identifiable fields than disclosed herein. In addition, security measures may include alternative approaches discoverable on the front side or back side of the check or discoverable by processing identified information. For example, the remote deposit feature in the mobile banking application running on the mobile computing device 102 may determine whether the payment amount 212 and the written amount 214 are the same. Additional processing may be needed to determine a final amount to process the check if the two amounts are inconsistent. In one non-limiting example, the written amount 214 may supersede any amount identified within the amount field 212.

In some embodiments, OCR of the check, implementing instructions resident on the customer's mobile device or at a backend server, processes each of the field locations on the check systematically. For example, the check may be scanned from top to bottom and fields may be identified as they are scanned. Real-time OCR or instant OCR is described in U.S. application Ser. No. 18/092,617, filed Jan. 3, 2023 and titled “INSTANT OPTICAL CHARACTER RECOGNITION DURING UPLOAD PROCESS,” which is incorporated by reference in its entirety. Alternatively, the entire check may be captured and processed via OCR by instructions resident on the customer's mobile device or at a backend server that process each of the field locations on the check, either simultaneously or sequentially.

In some embodiments, the mobile banking application may be opened on the mobile device, the check deposit function selected, the camera may be activated, the camera frame buffer populated with an image of the check, real-time OCR performed on the data from the camera frame buffer while on the mobile device, and the identified fields communicated to a check assessment model for determination of a likelihood (e.g., a confidence score) that the check corresponds to legitimate deposit activity (and/or a likelihood that the check corresponds to illegitimate deposit activity).

In some embodiments, fields that include typed information, such as the MICR line 220, check number 206, payer name 202, and address 204, etc., may be processed first, followed by a more complex or time intensive OCR process of identifying written fields, such as the payee field 210 and/or signature 218, to name a few. In this and other embodiments, the more complex OCR may be performed on the backend server.

In some embodiments, the front side imagery may be processed followed by the back side imagery. Alternatively the front side and back side imagery may be captured, stored and then processed together.

As noted above, OCR can be performed on a bank or third party server. In one implementation for initiating OCR of document images at the backend system, for example, the technology disclosed herein may add a request tag to one or more of the document images that are transmitted to the backend system with the request tag indicating that OCR is to be performed. As another example, the document upload application (e.g., a mobile banking application) may upload the document images and provide an OCR API (Application Programming Interface) call as separate communications to the backend system, with the OCR API call instructing the backend system to perform the OCR process.

In some embodiments, the ML platform 329, as described with respect to FIG. 3 may be used to train and/or implement OCR processing model(s). In a non-limiting example, computer vision algorithms may use large language models (LLM). A large language model is a language model characterized by emergent properties enabled by its large size. As language models, they work by taking an input text and repeatedly predicting the next token or word. They may be built with artificial neural networks, pre-trained using self-supervised learning and semi-supervised learning, typically containing tens of millions to billions of weights. In some aspects, LLM includes Natural Language Processing (NLP). Natural language processing is an interdisciplinary subfield of linguistics, computer science, and artificial intelligence concerned with the interactions between computers and human language, in particular how to program computers to process and analyze large amounts of natural language data. The goal is a computer capable of “understanding” the contents of images, including the contextual nuances of the language within them. The technology can then accurately extract information and insights contained in the images as well as categorize and organize the images or fields within images themselves.

Therefore, the technology described herein solves one or more technical problems that exist in the realm of online computer systems and in particular, with automated remote check deposit processes that unnecessarily delay providing a remote deposit status or improperly process illegitimate deposits. These problems are rooted in the difficulties faced by banks in determining whether an electronic image of a check depicts represents a legitimate deposit attempt, since banks do not have physical access to the check to verify certain characteristics that indicate a valid check (e.g., a working MICR line, proper paper thickness, serrations from a tear line, etc.). Banks that operate computer systems relying on an image of a check to complete remote deposits may not be able to verify that the MICR line of a check actually contains magnetic ink. Given a more accurate electronic means of determining whether or not a check is valid based on image analysis and/or location data, banks may reject a submission in real time or more readily detect that a check is likely counterfeit. The technology as described herein provides an improvement in the process of evaluating check images to identify instances of attempted illegitimate deposit activity. One or more solutions described herein are necessarily rooted in computer technology, since the conveniences of remote check deposit must be coupled with mobile GPS technology and pixel-by-pixel analysis of an image of a check to determine capture location, deposit location, text content (e.g., MICR line), and/or image-of-image characteristics as described herein. The technology described herein reduces or eliminates the problems faced by conventional document processing methods as will be described in the various embodiments herein. While described in the context of banking, the concepts disclosed herein apply to any document image capture and transmission scenario in which the recipient does not receive a physical copy of the document but relies upon information contained therein to provide services or access to the party sending the document image (e.g., image capture of a driver's license to provide access to an online account).

FIG. 3 illustrates a remote deposit system architecture 300, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 3, as will be understood by a person of ordinary skill in the art.

As described throughout, a client device 302 (e.g., mobile computing device 102) implements remote deposit processing for one or more financial instruments, such as checks. The client device 302 may be configured to communicate with a cloud banking system 316 to complete various phases of a remote deposit as will be discussed in greater detail hereafter.

In some embodiments, the cloud banking system 316 may be implemented as one or more servers. Cloud banking system 316 may be implemented as a variety of centralized or decentralized computing devices. For example, cloud banking system 316 may be a mobile device, a laptop computer, a desktop computer, grid-computing resources, a virtualized computing resource, cloud computing resources, peer-to-peer distributed computing devices, a server farm, or a combination thereof. Cloud banking system 316 may be centralized in a single device, distributed across multiple devices within a cloud network, distributed across different geographic locations, or embedded within a network. Cloud banking system 316 can communicate with other devices, such as a client device 302. Components of cloud banking system 316, such as application programming interface (API) 318, file database (DB) 320, as well as backend 322, may be implemented within the same device (such as when a cloud banking system 316 is implemented as a single device) or as separate devices (e.g., when cloud banking system 316 is implemented as a distributed system with components connected via a network).

In some embodiments, mobile banking application (app) 304 may be a computer program or software application designed to run on a mobile device such as a phone, tablet, or watch. However, in a desktop application, a desktop equivalent of the mobile banking app may be configured to run on desktop computers. In some embodiments, mobile banking app 304 may be a web application, which runs in a mobile web browser rather than directly on a mobile device. Applications or apps may be broadly classified into three types: native apps, hybrid, and web apps. Native applications may be designed specifically for a mobile operating system, such as iOS or Android. Web apps may be designed to be accessed through a web browser. Hybrid apps may be built using web technologies such as JavaScript, CSS, and HTML5, and may function like web apps disguised in a native container.

Camera 308 may capture images, video, image or video streams, or a combination of any of these or future image formats. Camera 308 may capture imagery of financial instruments, such as checks, for a remote deposit process. For example, one or more check images of a check 106 may be captured for an electronic remote deposit. A customer using client device 302, operating a mobile banking app 304 through an interactive UI 306, may capture one or more images of at least a portion of a check (e.g., identifiable fields on front or back of check) with camera 308. In some embodiments, the images may be stored (e.g., at least temporarily) in computer memory. For example, check images may be stored locally in image memory 312, which may be, but is not limited to, a frame buffer, a video buffer, a streaming buffer, a virtual buffer, or permanent memory.

Mobile banking app 304, resident on client device 302, may include a computer instruction set to provide a secure mobile device banking session. Mobile banking app 304 may allow a customer to interact with their bank account information. For example, common functions may include, but are not limited to, checking an account balance, transferring money between accounts, paying bills, making deposits, to name a few examples.

In some embodiments, as illustrated in FIG. 3, an image processing system 310 may be resident on the client device 302. The image processing system 310 may process the captured and/or stored imagery to extract data from the imagery by identifying specific data located within sections of the check to be electronically deposited. In one non-limiting example, single identifiable fields, such as the payer name 202, MICR line 220 identifying payer and bank information (e.g., bank name, bank routing number, payer account number, and check number), date field 208, check amount 212 and written amount 214, and authentication (e.g., payee signature 222) and anti-fraud 224 (e.g., watermark), etc. may be sequentially processed by an OCR program and/or OCR ML model within image processing system 310. Alternatively, or in addition, all identifiable check fields may be processed simultaneously by the OCR program and/or OCR ML model. In one non-limiting example, identifiable fields may be captured substantially within expected physical locations (e.g., boxes) on the front or back side of the check. In another non-limiting example, pixels from a mobile device camera frame buffer that include a perimeter of an expected payer signature 218 box, or slightly outside of the perimeter of the box (e.g., some signatures may exceed the expected perimeter), may be communicated to a remote image processing system including an OCR program and/or OCR ML model. In some embodiments, rather than image processing system 310 being resident on client device 302, some or all of image processing system 310 may be resident on cloud banking system 316. In some embodiments, portions of image processing system 310 may be resident on client device 302 while other portions of image processing system may be residence on cloud banking system 316.

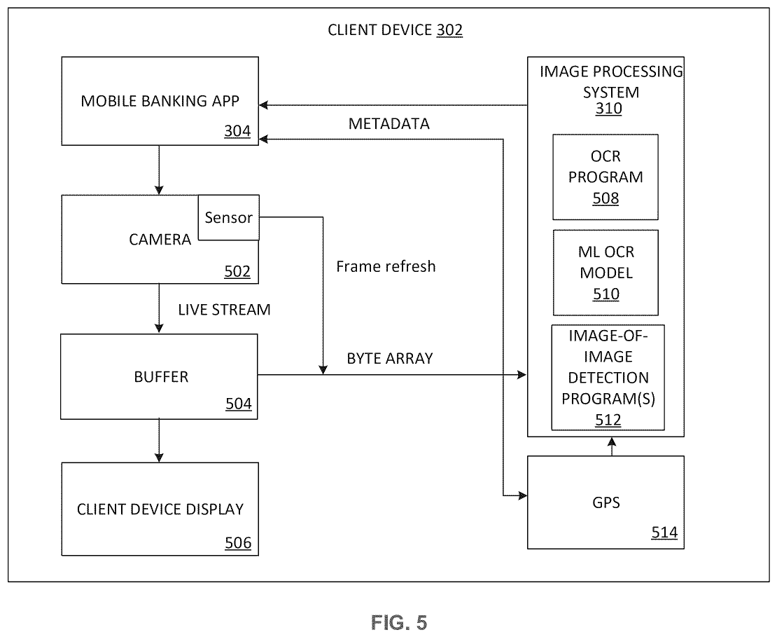

In some embodiments, in addition to performing OCR processing, image processing system 310 may perform image processing to determine image-of-image characteristics, as described with respect to FIG. 5. The image-of-image characteristics may include one or more of brightness, blue light levels, the presence or absence of a resolution feature, the presence or absence of a moiré pattern, and/or the presence or absence of one or more dot features and/or a dot feature pattern.

Account identification 314 may use single or multiple level login data from mobile banking app 304 alone or in combination with customer identifier information extracted during the OCR process to identify a customer's account.

In some embodiments, for example, when image processing system 310 is at least partially resident on client device 302, image processing system 310 may communicate data extracted from a check image to cloud banking system 316. For example, the extracted data may be communicated to file database (DB) 320 either through a mobile app server 332 or mobile web server 334 depending on the client device (e.g., mobile or desktop).

In some embodiments, backend 322 may include one or more system servers processing banking deposit operations in a secure closed loop. These one or more system servers may operate to support client device 302. API 318 may be an intermediary software interface between mobile banking app 304, installed on client device 302, and one or more server systems, such as, but not limited to the backend 322, as well as third party servers (not shown). The API 318 may be available to be called by mobile clients through a server, such as a mobile edge server, within cloud banking system 316. File DB 320 may store files received from the client device 302 or generated as a result of processing a remote deposit.

Profile module 324 may retrieve customer profiles associated with the customer from a registry after extracting customer data from front or back images of the financial instrument. Customer profiles may be used to determine deposit limits, historical activity, security data, or other customer related data. For example, the data on check image capture locations, deposit locations, image-of-image characteristics, and/or payers associated with a customer and described herein may be stored and retrieved by profile module 324.

Validation module 326 may generate a set of validations including, but not limited to, any of: mobile deposit eligibility, account, image, transaction limits, duplicate checks, amount mismatch, MICR, multiple deposit, etc. While shown as a single module, the various validations may be performed by, or in conjunction with, the client device 302, cloud banking system 316, or third party systems or data.

Customer Accounts 328 (consistent with customer account 408) may include, but is not limited to, a customer's financial banking information, such as individual, joint, or commercial account information, balances, loans, credit cards, account historical data, etc.

ML platform 329 may include a trained OCR or other image processing model and/or a ML engine to train image processing ML model(s), including ML OCR model(s), used to extract and process OCR data, brightness, blue light levels, the presence or absence of a resolution feature, the presence or absence of a moiré pattern, and/or the presence or absence of a dot feature and/or a dot feature pattern from an image of a check.

When a remote deposit status has been generated, it may passed back to the client device 302 through API 318, where it may be formatted for communication and display on client device 302 by mobile banking app 304 through UI 306. The UI may instantiate the remote deposit status as images, graphics, audio, additional content, etc.

Pending deposit 330 may include a profile of a potential upcoming deposit(s). If a deposit submission is successful, the system may create a record for the transaction and this function may retrieve a product type associated with the account, retrieve the interactions, and create a pending check deposit activity entry.

Alternatively, or in addition, to the configurations described above, one or more components of the remote deposit system may be implemented within the client device, third party platforms, the cloud-based banking system 316, or distributed across multiple computer-based systems.

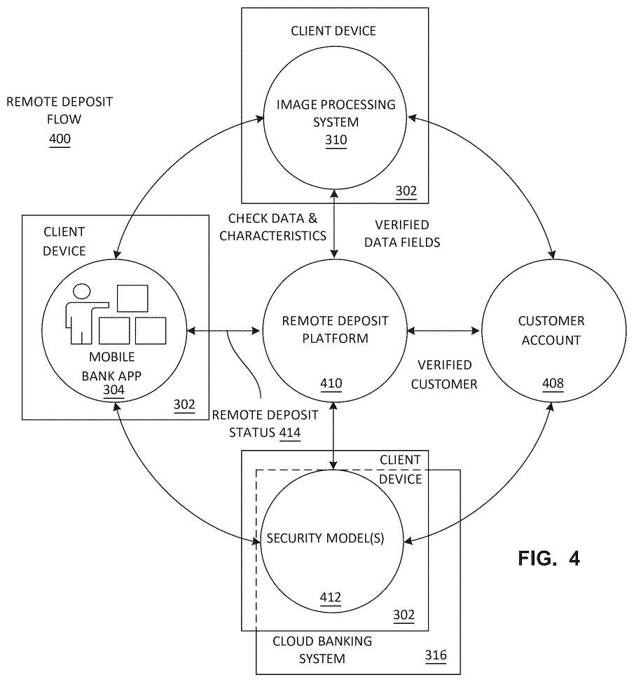

FIG. 4 illustrates an example flow diagram of a remote deposit system, according to some embodiments. The remote deposit flow 400 may include one or more system servers processing banking deposit operations in a secure closed loop. While described for a mobile computing device, desktop solutions may be substituted without departing from the scope of the technology described herein. These system servers may operate to support mobile computing devices from the cloud. It is noted that the structural and functional aspects of the system servers may wholly or partially exist in the same or different ones of the system servers or on the mobile device itself. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 4, as will be understood by a person of ordinary skill in the art.

In some embodiments, a bank customer using client device 302 (e.g., mobile computing device 102), operating a mobile banking app 304, may capture one or more images of at least a portion of a check with a camera on client device 302. The client device 302 may temporarily store the imagery in local memory (e.g., frame buffer) and may process the captured imagery using a client device 302 resident image processing system 310. Alternatively, or in addition, the client device may transmit the one or more captured images to a backend system (e.g., cloud banking system 316) for processing. In some embodiments, the camera may be remote to client device 302. In an alternative embodiment, the remote deposit may be implemented on a desktop computing device.

Image processing system 310 may communicate one or more data fields and/or image-of-image characteristics extracted in an image processing operation to security model(s) 412. For example, image processing system 310 may communicate one or more of an image capture location, a deposit location, the contents of the MICR line, brightness, blue light levels, whether or not a resolution feature has been identified (binary and/or a confidence score), whether or not a moiré pattern has been identified (binary and/or a confidence score), whether or not two dot features have been identified (binary and/or confidence score), and a dot feature pattern. Based on one or more items of such data, one or more security models 412 may compute a likelihood that a check image corresponds to legitimate deposit activity (and/or a likelihood that the check image corresponds to illegitimate deposit activity). For example, the one or more security models 412 may compute one or more confidence scores indicating the likelihood that the check image corresponds to legitimate deposit activity (e.g., a depicted check is not counterfeit and/or belongs to the customer). Additionally or alternatively, the one or more security models 412 may compute one or more confidence scores indicating the likelihood that the check image corresponds to illegitimate deposit activity (e.g., a depicted check is counterfeit and/or does not belong to the customer).

In some embodiments, security model(s) 412 may include a first model (e.g., check assessment model 606 discussed with respect to FIG. 6) that implements the described comparison of data associated with a customer check to data associated with past checks deposited by the customer (and/or standard baselines) to determine the likelihood that the check corresponds to legitimate deposit activity and/or a likelihood that the check corresponds to illegitimate deposit activity (e.g., represented by a confidence score). Based on the confidence score, an incident detection engine (e.g., incident detection engine 608 discussed with respect to FIG. 6) may determine that the check represents a high security risk (e.g., the confidence score meets a predetermined threshold). The incident detection engine may generate a remote deposit status 414 which may be provided to the customer in real time (e.g., as a response to the customer capturing an image and/or submitting a deposit request in mobile banking app 304, before the customer closes mobile banking app 304). In such embodiments, remote deposit flow 400 may bypass a second model which may conduct a more in-depth analysis of check data and/or user history to determine a security risk. Alternatively, if the confidence score does not meet the predetermined threshold, remote deposit flow 400 may forward data associated with the customer check to the second model to determine a final security risk determination. In some embodiments, even if the confidence score meets the predetermined threshold, remote deposit flow 400 may forward data associated with the customer check to the second model to determine the final security risk determination. The final security risk determination and/or the results of the first model may be used in the training and/or calibration of security model(s) 412. In some embodiments, security model(s) 412 may include no second model.

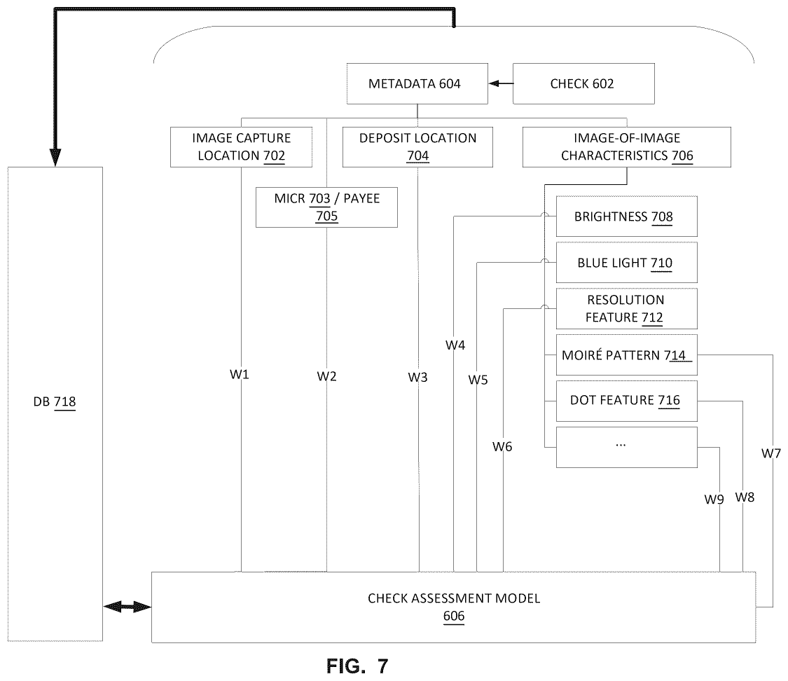

In some embodiments, the first model may be at least partially resident on client device 302, for example, within mobile banking app 304. In such embodiments, the first model may retrieve data from file DB 320 and/or DB 718 (described with respect to FIG. 7). In some embodiments, the first model may be at least partially resident on cloud banking system 316, for example, in validation module 326 or ML platform 329.

As noted above, security model(s) 412 may include a second model, for example, an ML model. In some embodiments, image processing system 310 may communicate one or more data fields extracted in an OCR operation to the second model, which may be an ML security model processed by ML platform 329. For example, image processing system 310 may communicate one or more of customer data (e.g., name, address, and/or account number), bank information (e.g., routing number), check number, check amount (e.g., funding amount needed), authorization and anti-fraud information (e.g., signature verifications, watermark or other check security imagery), etc. The second model may also receive customer historical deposit data from customer account 408. Based on one or more of the above pieces of information, the second model may also return a confidence score indicating a likelihood a deposit attempt is legitimate (and/or a confidence score indicating a likelihood the deposit attempt is illegitimate).

In some embodiments, the final security risk determination may depend on the outputs (e.g., confidence scores) of both the first and second models. In some embodiments, the final security risk determination may depend on the output of the second model alone. In some embodiments, the second model need not consider data specific to a current deposit attempt, but may consider only customer historical data (payee and/or payer history), such that the output of the second model is customer (or payee and payer pair) specific rather than specific to a deposit attempt. In such embodiments, the output of the second model may be used to modulate the output of the first model (e.g., the predetermined threshold(s) may be more strict, or easier to meet, for customers who have displayed deposit behavior more closely associated with security risks in the past).

In some embodiments, a better customer history (e.g., larger average daily balance, higher credit history, etc.) may lead to a better confidence score (representing less likelihood of illegitimate deposit activity), whereas a poor customer history may represent a deposit security risk. As such, based on an analysis of other customer's historical actions and deposit attempt data, a dynamically generated risk assessment may be generated that is customized to the customer or to a customer of a similar profile. But again, in some cases, use of the second model may be bypassed if the first model indicates up front a high likelihood that a customer check corresponds to illegitimate deposit activity (and/or a low likelihood that the customer check corresponds to legitimate deposit activity).

Customer account 408 may include, but is not limited to, a customer's financial banking information, such as individual, joint, or commercial account information, balances, loans, credit cards, account historical data, etc. The customer account 408, for the purposes of this disclosure, may be the payee's account, the payer's account, or both. For example, a payee's account historical information may be used to calculate a payee-specific confidence score using a security model 412, while a payer customer's account 408 may be checked for funds to cover the check amount. Early access to the payer customer's account 408 may also provide a verified customer for security purposes to eliminate or reduce illegitimate deposit attempts early in the remote deposit process.

In one non-limiting example, an address may be checked against the current address found in a data file of customer account 408. In another non-limiting example, OCR processing may include checking a signature file within customer account 408 to verify the payee or payer signatures. Additional known OCR post processing techniques may be substituted without departing from the scope of the technology described herein.

Security model(s) 412 may communicate, via mobile banking app 304 and/or remote deposit platform 410, a remote deposit status 414 to the customer. The remote deposit status 414 may be generated based on the results of the first model and/or the second model. The remote deposit status may be communicated to and rendered on-screen on the customer's device within one or more UI's of the customer device's mobile banking app 304. The rendering may include imagery, text, or a link to additional content. For example, if the first model has determined, based on data associated with an image of a check, that the check has a high likelihood of corresponding to illegitimate deposit activity (and/or a low likelihood of corresponding to legitimate deposit activity), the remote deposit status 414 may include a message such as, “We are not able to accept your mobile deposit submission. Please deposit your check in-person,” or any similar message. The UI may instantiate the remote deposit status as images, graphics, audio, etc.

One or more of the security model(s) 412 may be implemented within the customer device (e.g., client device 302), third party platforms, a cloud-based system (e.g., cloud banking system 316), or distributed across multiple computer-based systems. For example, in one embodiment, the first security model 412 may be implemented within cloud banking system 316 and/or client device 302 while the second security model 412 may be implemented within cloud banking system 316 and/or a third party platform.

In some embodiments, ML platform 329 may include an ML funds availability model that may compute a funds availability schedule based on one or more of data fields received from real-time OCR processing, customer history received from a customer account 408, bank funding policies, legal requirements (e.g., state or federally mandated limits and reporting requirements, etc.), or typical schedules stored within the funds availability model, to name a few. This process is described in U.S. application Ser. No. 18/509,748, filed Nov. 15, 2023 and titled “DEPOSIT AVAILABILITY SCHEDULE,” the disclosure of which is incorporated by reference in its entirety. In some embodiments, the output(s) of security model(s) 412 may be used to calculate a funds availability schedule, either using the ML funds availability model disclosed in U.S. application Ser. No. 18/509,748 or a different model. For example, in some embodiments, a higher confidence score determined by a security model 412 may factor into a funds availability model computing a funds availability schedule with an earlier available deposit date.

In various aspects, the funds availability schedule may be generated by ML platform 329. For example, the ML funds availability model may be trained to process the received data fields, customer history, etc., as described in U.S. application Ser. No. 18/509,748.

FIG. 5 illustrates an example diagram of a client device 302, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 5, as will be understood by a person of ordinary skill in the art.

In one embodiment, the mobile banking app 304 may opened on the client device 302 and the check deposit function may be selected to initiate a remote deposit process. A camera may be activated (e.g., camera 502) to communicate a live stream of imagery (e.g., frames of video) from a field of view of the camera 502. Camera 502 may output, for display at client device display 506, a frame (e.g., an image frame or a frame of a video, for example) having one or more images (e.g., images of real-world objects) that are viewable by camera 502. An image frame may include one or more images that may represent one or more real-world objects. For instance, an image may represent an entire group of checks in a field of view of camera 502, or the image may represent one or more individual objects within the group. In some embodiments, an image of decodable check indicia may be provided by a raw image byte stream or by a byte array, a compressed image byte stream or byte array, and/or a partial compressed image byte stream or byte array.

The customer of the client device 302 may view the live stream of imagery on a UI of the client device display 506, after buffering in buffer 504 (e.g., frame buffer, video buffer, etc.). In some embodiments, the live stream may be communicated to image processing system 310 as a raw image live stream. In some embodiments, the raw image live stream may be first converted to a byte array and then communicated to image processing system 310 (buffered or not buffered). The data embedded in the byte stream or byte array may then extracted by program instructions of an OCR program 508 and/or image-of-image detection program(s) 512 of image processing system 310 and saved to memory of the client device 302. This extracted data may be continuously transmitted, periodically transmitted, or transmitted after completion of image processing (e.g., after all data fields and check image-of-image characteristics are extracted) to mobile banking app 304 and/or a cloud banking system 316 via a network connection. In some embodiments, the extracted data may be sent to cloud banking system 316 by mobile banking app 304 with an image frame or image frames from which the data was extracted. In some embodiments, the extracted data may be stored in a metadata file that may be sent with the image frame or image frames.

In some embodiments, the remote deposit platform 410, as described with respect to FIG. 4, may be used to assist implementation of the localized mobile device image processing. In a non-limiting example, computer vision algorithms may use large language models (LLM). A large language model is a language model characterized by emergent properties enabled by its large size. As language models, they work by taking an input text and repeatedly predicting the next token or word. They may be built with artificial neural networks, pre-trained using self-supervised learning and semi-supervised learning, typically containing tens of millions to billions of weights. In some aspects, LLM includes Natural Language Processing (NLP). One goal is a computer capable of “understanding” the contents of images, including the contextual nuances of the language within them. The technology can then accurately extract information and insights contained in the images as well as categorize and organize the images or fields within images themselves. LLM and NLP functionality may be implemented on the remote deposit platform 410 to train and improve a ML OCR model 510 that may be operative with the mobile device for localized active OCR processing.

In some embodiments, the front side imagery may be processed followed by the back side imagery. Alternatively, the front side and back side imagery may be processed together or in parallel.

In some embodiments, image-of-image detection program(s) 512 can include one or more programs for processing an image of a check to determine one or more image-of-image characteristics, which may include brightness, blue light levels, the presence or absence of a resolution feature, the presence or absence of a moiré pattern, and/or the presence or absence of one or more dot features and/or a dot feature pattern.

Example methods for determining these image-of-image characteristics will now be described. However, these examples are not meant to limit this disclosure to any particular methods for determining the below characteristics. The below characteristics may be determined by image-of-image detection program(s) 512 in any manner as known in the art.

Brightness: In some embodiments, brightness may refer to the intensity of light as measured by camera sensor(s) of camera 502 of client device 302 (and optionally gamma-corrected, as describe below). In such embodiments, the brightness may be calculated from pixel data (e.g., RGB values), where each color channel is associated with a value that indicates the intensity of light stored by that channel. For example, in the RGB color space, the color channels may be red, green, and blue, and pixel data may include intensity values for red, green, and blue light. When the intensity values are each stored in a byte, the intensity values may be from 0 to 255 or some function of 0 to 255, depending on the color space used. In some embodiments, when RGB values are used, brightness may be a function of the red, green, and blue intensity values for each pixel of an image (e.g., added together with or without coefficients associated with each value), averaged over the image. In some embodiments, brightness may be a function of the red, green, and blue intensity values for each pixel of a portion of an image, averaged over the portion of the image.

Other color spaces may be used. For example, in some embodiments, a Y′UV color space (e.g., YCbCr) may be used. Y′ may represent a luma channel. Values of the luma channel may indicate a luminance (perceived, not an absolute luminance of a point on an object) calculated from gamma-corrected RGB input. In some embodiments, a conversion between an RGB color space and a Y′UV color space may be performed by image-of-image detection program(s) 512, which in some embodiments may be implemented within mobile banking app 304. When a Y′UV color space is used, brightness may be values of the luma channel for each pixel, averaged over the image. In some embodiments, brightness may be the values of the luma channel for each pixel of a portion of an image, averaged over the portion of the image.

While RGB and Y′UV color spaces are mentioned, any color space may be used (e.g., HEX, CMYK, HSL, HSB, etc.) and brightness for all or a portion of the image may be determined from pixel data of any color space. Image-of-image detection program(s) 512 may also be capable of performing various conversions between color spaces to determine brightness. In some embodiments, brightness may be determined automatically by pre-existing programs in a client device 302 and may be listed as a value in EXIF metadata that accompanies a captured image.

In some embodiments, brightness as used herein may be a normalized brightness. That is, brightness may refer to a calculated value that indicates absolute luminance of a captured scene or an object within the scene. In such embodiments, brightness as determined above may be normalized based on one or more of the following factors: focal length/aperture (together, f-number), ISO value, shutter speed (exposure time), distance to a captured object (as measured from the camera), flash setting, and gamma correction applied at the time of image capture.

The relationships between each of these factors and brightness, along with how data on these factors may be obtained, is outlined below:

Focal length/aperture-A shorter focal length and/or larger aperture diameter (e.g., smaller f-number, where the f-number is commonly represented as N in the expression f/N) is associated with more light travelling through a camera lens, causing measured brightness of a captured image frame to increase. In some embodiments, the f-number at the time of image capture may be included in EXIF metadata that accompanies a captured image.

ISO value—ISO value indicates the sensitivity of a camera sensor to light. Higher ISO values are associated with more light being captured by a camera sensor, causing measured brightness of a captured image frame to increase. In some embodiments, the ISO value at the time of image capture may be included in EXIF metadata that accompanies a captured image.

Shutter speed—Shutter speed (exposure time) indicates how long light is allowed to enter the camera sensor in capturing an image frame. A slower shutter speed (longer exposure time) is associated with more light entering the camera sensor, causing measured brightness of a captured image frame to increase. In some embodiments, the shutter speed at the time of image capture may be included in EXIF metadata that accompanies a captured image.

In some embodiments, focal length/aperture, ISO value, and shutter speed may be combined into a single representation of exposure that is calculated by image processing system 310 and included in EXIF metadata that accompanies a captured image.

Distance—The distance to a captured object influences how much light emitted or reflected by the object enters the camera sensor. A greater distance is associated with less light entering the camera sensor, causing measured brightness of a captured image frame to decrease, and vice versa with a shorter distance. In some embodiments, distance from a camera to a captured object may be determined by leveraging augmented reality (AR) capabilities of client device 302. For example, mobile banking app 304 may interact with an AR platform on client device, within which an AR framework such as ARKit (IOS) or ARCore (Android) may operate. The AR platform may include software and internal sensors (e.g., gyroscopes, accelerometers, magnetometers, and/or LiDAR sensors, ToF sensors, etc.) that can determine a real world position and orientation of various objects within the field of view of camera 502 both relative to a real world coordinate system and relative to camera 502, as described in more detail in U.S. patent application Ser. No. 18/529,623, filed Dec. 5, 2023 and titled “AUGMENTED REALITY DATA CAPTURE AID,” the disclosure of which is incorporated by reference in its entirety. Using the AR platform, mobile banking app 304 can obtain data on the real world distance between a plane (e.g., check 106) detected in the field of view of camera 502, for example, by leveraging plane detection and calculating distance to the center or a surface of the plane using the plane's coordinates. In some embodiments, additionally or alternatively, the distance may be determined from an output of a LiDAR sensor or ToF sensor. In some embodiments, additionally or alternatively, the distance may be determined using multiple lenses and/or cameras on client device 302, data from each of which may be compared to obtain depth data. For example, the difference in location of an object within two images captured using two lenses on the same device may be used to calculate distance to the object from the lenses.

Flash setting—The presence of a flash at the time of image capture may dramatically increase measured brightness. In some embodiments, the flash setting (e.g., flash/no flash) at the time of image capture may be included in EXIF metadata that accompanies a captured image.

Gamma correction—The gamma correction refers to an adjustment of measured light intensity (brightness) at the pixel level to provide tonal correction for an output display, originally CRT (cathode ray tube) monitors. Most images (e.g., JPEG, HEIC images) still include pixel data that has been gamma-corrected, though gamma correction may not be present in RAW image files. Accordingly, gamma correction in pixel data may cause differences between real-world light intensity at the camera sensor and light intensity values as determined from encoded pixel data of an image file. Gamma correction for a given pixel value (e.g., a value of the R channel in an RGB image) may be described by the following equation: P′=P^{γ}, where P′ is a gamma-corrected pixel value, P is a detected pixel value, and γ is the gamma value for the gamma correction. Accordingly, a gamma value (e.g., 2.2) may indicate the extent of gamma correction applied. In some embodiments, one or more gamma values for a gamma correction applied to pixel data of a captured image may be included in an image file.

Accordingly, brightness as determined from pixel data of an image frame may be normalized based on one or more of the above factors, depending on which are available for a given image capture, to obtain a normalized brightness that indicates absolute luminance of a captured scene or an object within the scene. In some embodiments, for example, a normalized brightness for a given pixel may be represented according to the following equation:

$${B}_{N} = {B}^{\frac{1}{γ}} * \frac{{Nd}^{2}}{ISF}$$

where B_{N} represents the normalized brightness, B represents the brightness for a pixel determined from gamma-corrected pixel data, γ is the gamma value for the gamma correction for the pixel, N is the f-number, d is the distance from the camera of the object, I is the ISO value, S is the shutter speed, and F represents a flash setting (e.g., 1 if no flash used, 5 if flash used). This equation is provided as an example equation. Any equation may be used which captures the following relationships: normalized brightness for a pixel generally increases as recorded brightness increases, decreases as the gamma value increases, increases as the f-number increases, increases as the distance from the camera to the captured object increases (according to an r² law, since perceived luminance falls off at 1/r² as distance from an object increases), decreases as the ISO value increases, decreases as the shutter speed (exposure time) increases, and decreases if a flash was used. Any constant may be added before any of the terms of the above equation, and any constant exponent may be applied to any of the variables, in order to more accurately represent normalized brightness (indicating absolute luminance of a captured scene or an object within the scene).

The normalized brightness of an image may be the average of normalized brightness values for all pixels of an image. The normalized brightness of a portion of an image may be the average of normalized brightness values for all pixels of the portion of the image.

In some embodiments, a normalized brightness may be calculated after pixel data is gamma decoded (i.e., gamma correction reversed). In such embodiments, the gamma value may be removed from the above equation and B may represent the brightness for a pixel determined from non-gamma-corrected pixel data.

Excessive brightness (including normalized brightness) in an image, as compared to that of previous deposit images or a baseline value, may indicate that an image is an image of an electronic display (e.g., a computer or mobile phone screen), since electronic displays are backlit. Accordingly, this may be an indicator that no real object apart from a screen of a device (e.g., no real check) is depicted in the image.

It should be understood that any reference to “brightness” herein (e.g., brightness 708) may refer to measured brightness (either using gamma-corrected pixel data or gamma-decoded pixel data) or normalized brightness.

Blue Light Level: In some embodiments, blue light level may refer to the intensity of blue light as measured by camera sensor(s) of camera 502 of client device 302. The intensity of blue light for an image frame may be calculated from pixel data (e.g., RGB values), as described above for brightness. In some embodiments, for example, when an RGB color space is used), blue light levels may be a function of the blue light intensity values for each pixel of an image (e.g., added together or averaged over the image). In some embodiments, brightness may be a function of the blue light intensity values for each pixel of a portion of an image (e.g., added together or averaged over the portion of the image).

Any color space (e.g., RGB, Y′UV, HEX, CMYK, HSL, HSB, etc.) may be used and blue light level for all or a portion of the image may be determined from pixel data of any color space. Image-of-image detection program(s) 512 may be capable of processing color codes for any color space to determine blue light intensity. Image-of-image detection program(s) 512 may also be capable of performing various conversions between color spaces to determine blue light level.

In some embodiments, the blue light level may be a relative blue light level. In such embodiments, the blue light level may indicate a blue light intensity for an image or a portion of an image relative to other color intensities for the pixels of the image or the portion of the image. For example, in some embodiments, the relative blue light level may be expressed as a ratio of average blue light intensity across a certain collection of pixels (which could be an entire image) to an average light intensity of data from other color channels across the collection of pixels (e.g., an average of averages, such as an average of mean red light intensity and mean green light intensity). In some embodiments, the relative blue light level may be expressed as a ratio of total blue light intensity across a certain collection of pixels (which could be an entire image) to an average of total light intensity of data from other color channels across the collection of pixels (e.g., an average of total red light intensity and total green light intensity). Any other method of determining intensity of blue light of an image or a portion of an image relative to other colors in the image may be used. Additionally, the blue light level may be a normalized blue light level, calculated using similar methods as described above for the normalized brightness. In some embodiments, when the blue light level is a relative blue light level, it need not be normalized.

An excessive blue light level (including a relative blue light level) in an image, as compared to that of previous deposit images or a baseline value, may indicate that an image is an image of an electronic display (e.g., a computer or mobile phone screen), which emit a higher percentage of blue light as compared to natural light and the vast majority of lamps. Accordingly, this may be an indicator that no real object apart from a screen of a device (e.g., no real check) is depicted in the image.

It should be understood that any reference to “blue light” herein (e.g., blue light 710) may refer to a blue light level, a relative blue light level, or a normalized blue light level.

In some embodiments, pixel data and/or metadata for determining any of the above values may be stored in any known file format, for example, a JPEG, PNG, TIFF, HEIC, or RAW file, or any other file type that supports metadata storage, before or after being provided to image processing system 310. In some embodiments, metadata may be stored in a variety of formats within an image file, including one or more of EXIF, XMP, XML, 8BIM, IPTC, or ICC formats.

Resolution Feature: In some embodiments, a resolution feature may refer to a regularly repeating color and/or brightness pattern identifiable from pixel data using image processing. For example, image-of-image detection program(s) 512 may be configured to analyze pixel data to determine whether a particular pixel color and/or brightness configuration regularly repeats along an axis (e.g., horizontal or vertical). If the image-of-image detection program(s) 512 determine that a particular pixel color and/or brightness configuration repeats along an axis, this may be evidence that an object in the image has a resolution (e.g., is an electronic display with pixels). Accordingly, this may be an indicator that no real object apart from a screen of a device (e.g., no real check) is depicted in the image.

While the above method is provided as an example, any known method for determining whether an image contains a resolution feature may be used.

Moiré Pattern: In some embodiments, a moiré pattern may refer to a visual pattern caused by the interference of a pixel configuration of an electronic display with a pixel configuration of a camera sensor. A moiré pattern may be caused by the repetitive pattern of a photographed object (e.g., a pixel array of a screen) misaligning with the repetitive pattern of the camera sensor pixel array, causing an interference pattern that may appear as diffracted color spectra and/or intensity peaks and troughs. In some embodiments, a moiré pattern may be detected using a machine learning (ML) model, for example a convolutional neural network (CNN) that may be trained to identify images that include a moiré pattern. Moiré patterns may be detected using any of the methods described in Abraham, “Moiré Pattern Detection using Wavelet Decomposition and Convolutional Neural Network,” Amadeus Software Labs Pvt. Ltd, IEEE (2018) or in Yang, et al., “Doing More with Moiré Pattern Detection in Digital Photos,” Journal of Latex Class Files, Vol. 14, No. 8 (August 2021). The contents of both of these references are incorporated by reference herein in their entireties. Accordingly, in some embodiments, image-of-image detection program(s) 512 may include a ML model that is either implemented on client device 302 or ML platform 329. While the above method is provided as an example, any known method for determining whether an image contains a moiré pattern may be used.

The presence of a moiré pattern in an image may be evidence that an object in the image is an electronic display with pixels. Accordingly, this may be an indicator that no real object apart from a screen of a device (e.g., no real check) is depicted in the image.

Dot Feature: In some embodiments, a dot feature may refer to a machine identification code (MIC) included in a printed document (e.g., an image of a check printed on a sheet of paper). The MIC of a printed document may indicate the serial number of the printing device used to print the document, along with print date and time. The MIC of a printed document may be a series of small yellow (or other color) dots that are barely visible or invisible to the naked eye.

In some embodiments, image-of image detection program(s) 512 may detect and identify a MIC by identifying yellow pixels from pixel data. For example, image-of-image detection program(s) 512 may identify pixels with RGB values that indicate blue light intensity below a predetermined threshold and red and green light intensity within a predetermined threshold difference of one another. In some embodiments, image-of-image detection program(s) 512 may log the relative locations of identified yellow pixels within an image frame (e.g., based on location data of pixel data stored in a byte array). The relative locations may be used to identify a MIC based on the arrangement of yellow dots in an image. Other methods of identifying a MIC are disclosed in U.S. Pat. No. 5,515,451, issued May 7, 1996 and titled “IMAGE PROCESSING SYSTEM FOR SELECTIVELY REPRODUCING DOCUMENTS,” the disclosure of which is incorporated by reference herein in its entirety. While the above methods are provided as example methods, any known method for determining a MIC of a printed document from an image may be used.

In some embodiments, a MIC identified from an image may be compared (e.g., by a check assessment model 606) with MICs identified from images previously captured by a customer. A MIC identified from an image that does not match a MIC of any other previously captured image may indicate that a check in the image is not a real check, but is a printed image of a check. This may be particularly true when a MIC previously associated with the payer identified in the check (e.g., via the MICR line) does not match the MIC identified from the image.

In some embodiments, image-of-image detection program(s) 512 may be configured to assess whether an image includes two different MICs. In such a case, the first MIC may be a MIC in an originally printed document (e.g., a check), and the second MIC may be a MIC added by reproducing the originally printed document. The presence of two different MICs may indicate that a check is not a real check, but is a printed image of a check. In some embodiments, image-of-image detection program(s) 512 may determine whether an image includes two different MICs by identifying a group of MIC dots that has a slightly different hue from another group of MIC dots, and/or by comparing identified patterns of MIC dots to patterns stored in a database (e.g., DB 718 shown in FIG. 7).

Miscellaneous Image-of-Image Detection Methods: Alternatively, or in addition to using the various image-of-image characteristics described, various methods may be used to identify a captured image as an image of an image (not a real check). In some embodiments, for example, real-world dimensions of a representation of a check may be determined. These real-world dimensions may be determined by leveraging augmented reality (AR) capabilities of client device 302. For example, mobile banking app 304 may interact with an AR platform on client device, within which an AR framework such as ARKit (IOS) or ARCore (Android) may operate. The AR platform may include software and internal sensors (e.g., gyroscopes, accelerometers, magnetometers, and/or LiDAR sensors, ToF sensors, etc.) that can determine a real world position and orientation of various objects within the field of view of camera 502 both relative to a real world coordinate system and relative to camera 502, as described in more detail in U.S. patent application Ser. No. 18/529,623, filed Dec. 5, 2023 and titled “Augmented Reality Data Capture Aid,” the disclosure of which is incorporated by reference in its entirety. Using the AR platform, mobile banking app 304 may obtain data on the real world length and width of a plane (e.g., a representation of a check) detected in the field of view of camera 502, for example, by leveraging plane detection and requesting plane extent data from the AR platform. In some embodiments, additionally or alternatively, real-world dimensions may be determined based on distance information gathered using multiple lenses and/or cameras on client device 302, as described above.

In some embodiments, image-of-image detection program(s) 512 and/or check assessment model 606 may compare the real-world dimensions to dimensions of known check types. If the real-world dimensions exceed or are below any known check type, this may indicate that the representation of the check in the image is not a real check, but is a printed image of a check or an image of a check displayed on an electronic display. The customer may be displaying an image of a check on a screen at a size that is much smaller or larger than an actual check size, but may be adjusting the distance from the camera to the screen such that the check appears to be the appropriate size, if no real-world dimensions were detected. Likewise, the customer may be doing the same with a printed image of a check.

While the above method is provided as an example, any known method for determining the real-world dimensions of an object in an image may be used.

Machine Learning Image-of-Image Detection Methods: In some embodiments, ML model(s) may be used to identify whether an image is an image of an image. For example, in some embodiments, an image classification model may be trained using supervised training. The training data may include images of images (e.g., an image of a screen), images of real checks, and labels identifying which are which. The image classification model may be trained and implemented as described in U.S. patent application Ser. No. 18/441,417, filed Feb. 14, 2024 and titled “REAL-TIME IMAGE VALIDITY ASSESSMENT,” the disclosure of which is incorporated by reference herein in its entirety. Specifically, in some embodiments, the image classification model may be trained as described with respect to confidence model 612 of FIG. 6 of U.S. patent application Ser. No. 18/441,417. The categorization data may be the labels indicating whether an image is an image of an image or not.

In some embodiments, the resulting trained image classification model may be implemented and/or refined on client device 302 as describe in U.S. patent application Ser. No. 18/441,417, for example, using Core ML or ML Kit.

In some embodiments, image-of-image detection program(s) 512 may determine one or more of the above image-of-image characteristics. In some embodiments, mobile banking app 304 and/or a program running on cloud banking system 316 may be configured to associate the one or more image-of-image characteristics with an image frame or image frames captured using camera 502. The one or more image-of-image characteristics may be stored with the associated image frame or image frames in a database, for example, file DB 320 (or database 718 described with respect to FIG. 7). In some embodiments, the one or more image-of-image characteristics may be stored without storing an image frame or image frames.

In some embodiments, image-of-image detection program(s) 512 may include programs for determining all of the above image-of-image characteristics. In some embodiments, image-of-image detection program(s) 512 may include programs for determining any subset of the above image-of-image characteristics, for example, any one of the above image-of-image characteristics alone. Including image-of-image detection program(s) 512 for determining multiple image-of-image characteristics may provide more accurate determinations of whether an image is an image of an image, but may not be necessary.

In cases where a determination is binary (e.g., presence/absence of resolution feature, presence/absence of moiré pattern, presence/absence of two MICs, etc.), in some embodiments, the image-of-image detection program(s) 512 providing a binary determination may provide a corresponding confidence score indicating a confidence that the binary determination is correct for each binary determination provided by the image-of-image detection program(s) 512. In some embodiments, the confidence scores for binary determinations may be used by a check assessment model, such as check assessment model 606 discussed with respect to FIGS. 6-7. In some embodiments, the image-of-image detection program(s) 512 may provide a binary determination with no confidence score. In such embodiments, the binary determinations may be used by the check assessment model 606.

While shown on client device 302 in FIG. 5, in some embodiments, one or more of OCR program 508, ML OCR model 510, and image-of-image detection program(s) 512 may reside anywhere within remote deposit system architecture 300 shown in FIG. 3, for example in validation module 326 and/or ML platform 329. Additionally, in some embodiments, one or more of OCR program 508, OCR ML model 510, and image-of-image detection program(s) 512 may reside on a third party platform. The location of these models and programs should not limit the scope of the present disclosure, as the image processing functions performed by image processing system 310 and described herein may be performed on any software platform upon the provision of a check image to one or more components of image processing system 310. For example, in some embodiments, one or more of the image processing functions described herein (e.g., OCR or detection of any of the image-of-image characteristics) may be performed in real time at client device 302 based on image frames received from camera 502. Likewise, alternatively or additionally, one or more of the image processing functions described herein may be performed at cloud banking system 316 based on an image or multiple images collected by camera 502 and uploaded to cloud banking system 316 by mobile banking app 304.

In some embodiments, all of image-of-image detection program(s) 512 may reside on client device 302. In some embodiments, a subset of image-of-image detection program(s) 512 may reside on client device 302 while another subset of image-of-image detection program(s) 512 may reside on cloud banking system 316 and/or a third party platform. In some embodiments, all of image-of-image detection program(s) 512 may reside on cloud banking system 316 and/or a third party platform.

As shown in FIG. 5, client device 302 may include a GPS 514. GPS 514 may provide location data for a check image. The location data may include one of or both of two locations: the location an image is captured and the location a deposit is being submitted (i.e., the location of client device 302 at the time the payee customer is interacting with mobile banking app 304 to submit a deposit). As shown in FIG. 5, GPS 514 may communicate the image capture location directly to image processing system 310 so that the image capture location may be added to the image file as metadata (e.g., EXIF metadata). As also shown in FIG. 5, mobile banking app 304 may query GPS 514 to obtain the deposit location at the time the payee customer is interacting with mobile banking app 304.

When an image has been captured at a different location and/or has been transmitted to client device 302 after being captured by another device, the image capture location may be inconsistent with the deposit location determined using GPS 514. In some cases, a payee customer may be able to select an image for remote deposit consideration that may have been captured at a different location and/or has been transmitted to client device 302 after being captured by another device. The payee customer may be able to do so by jailbreaking or rooting client device 302 to obtain improper access to the inner workings of mobile banking app 304, which typically only allows selecting images for mobile deposit that have been captured while using mobile banking app 304. Accordingly, a comparison of the image capture location and the deposit location may reliably assess whether a device has been tampered with to select fraudulent images for deposit. Such a comparison is described herein with respect to FIGS. 6 and 7.

FIG. 6 illustrates an example deposit security system including deposit pattern analysis infrastructure for an example customer deposit pattern 600. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 6, as will be understood by a person of ordinary skill in the art.

In some embodiments, the customer deposit pattern may include a plurality of checks 602, for example check 602a, check 602b, check 602c, check 602d, and check 602e. The plurality of checks may each be associated with a date, for example, an issue date. As used herein, “issue date” refers to a date printed or written on the check that indicates the date the payer authorizes funds to be transferred from the payer to the payee. As shown in FIG. 6, check 602a may be associated with an issue date of Dec. 15, 2023, check 602b may be associated with an issue date of Jan. 1, 2024, checks 602c-d may be associated with an issue date of Jan. 15, 2024, and check 602e may be associated with an issue date of Jan. 31, 2024. However, checks 602 may be associated with any issue dates. While the issue date is specifically identified herein, other dates associated with a check 602 may be used, such as the date the check 602 is provided for remote deposit. Checks 602 represent checks that have been provided by a customer for mobile deposit over a given time period.

In some embodiments, each of checks 602 may be associated with metadata 604. Metadata 604 may include one or more of OCR identified data (e.g., MICR, payer name, and/or payee customer name), customer data (e.g., payee customer name), location data (e.g., image capture location and/or deposit location), and the image-of-image characteristics discussed herein (e.g., brightness; blue light level; the presence of absence of a resolution feature and/or an associated confidence score; the presence or absence of a moiré pattern and/or an associated confidence score; and/or a dot feature, the presence of absence of two dot features, and/or an associated confidence score). In some embodiments, metadata 604 may be compiled into a metadata file that may be stored and/or transferred with an image or images of a check or by itself. As shown in FIG. 6, check 602a may be associated with metadata 604a, check 602b may be associated with metadata 604b, check 602c may be associated with metadata 604c, check 602d may be associated with metadata 604d, and check 602e may be associated with metadata 604e.

As shown in FIG. 6, metadata 604 may be transferred to a check assessment model 606. In some embodiments, metadata 604 may be transferred to check assessment model 606 via a database (DB), such as DB 718 shown in FIG. 7. In some embodiments, check assessment model 606 may include a software implemented algorithm that analyzes metadata 604 to recognize patterns and/or perform comparisons. For example, in some embodiments, check assessment model 606 may determine a location parameter associated with a payee customer, based on image capture location and/or deposit location data. The location parameter may represent a mobile deposit location pattern. Likewise, in some embodiments, check assessment model 606 may determine one or more visual metadata parameters associated with the payee customer, based on one or more of the image-of-image characteristics (e.g., brightness, blue light level, and/or dot feature).

In some embodiments, the location parameter and/or the one or more visual metadata parameters may further be associated with a common payer. For example, check assessment model 606 may identify, from a plurality of checks 602 (images of which have been analyzed as described above), a plurality of checks associated with a common payer, and determine the location parameter based on customer deposit patterns of checks issued by the common payer. In some embodiments, check assessment model 606 may identify a plurality of checks 602 associated with a common payer by analyzing MICR data within metadata 604 (i.e., an account number may indicate a payer). Alternatively, or in addition, check assessment model 606 may identify a plurality of checks 602 associated with a common payer by analyzing text content within metadata 604 (e.g., to identify a business or personal name and/or address).

In some embodiments, check assessment model 606 may sort checks provided for deposit by the payee customer. In some embodiments, check assessment model 606 may recognize when a threshold number of checks from a common payer has been met within a predetermined timeframe. In some embodiments, the threshold number can range from 3 to 50 checks, including subranges, within any predetermined timeframe. For example, in some embodiments, the threshold number can range from 5 to 40 checks, from 5 to 30 checks, from 5 to 20 checks, from 5 to 15 checks, or from 5 to 10 checks, within any predetermined time frame. For each of the ranges above, the predetermined timeframe can range from 1 month to 2 years, including subranges. For example, in some embodiments, the predetermined timeframe can range from 1 month to 1.5 years, from 1 month to 1 year, from 1 month to 9 months, from 1 month to 6 months, or from 1 month to 3 months. In some embodiments, when the threshold number of checks from the common payer has been met, check assessment model 606 may add the common payer to a “trigger list.” The trigger list may include payers for which check assessment model may perform additional analysis (e.g., comparison to common-payer specific parameters) if it determined that a future check 602 is associated with one of the payers on the trigger list.

In some embodiments, check assessment model 606 may analyze whether a location associated with the future check 602 corresponds to a location parameter associated with the payee customer and/or the common payer. In some embodiments, the location parameter may be determined based on location data included in metadata 604 (e.g., that obtained from GPS 514). In some embodiments, the location parameter may be determined based on deposit locations. In some embodiments, the location parameter may be determined based on image capture locations.

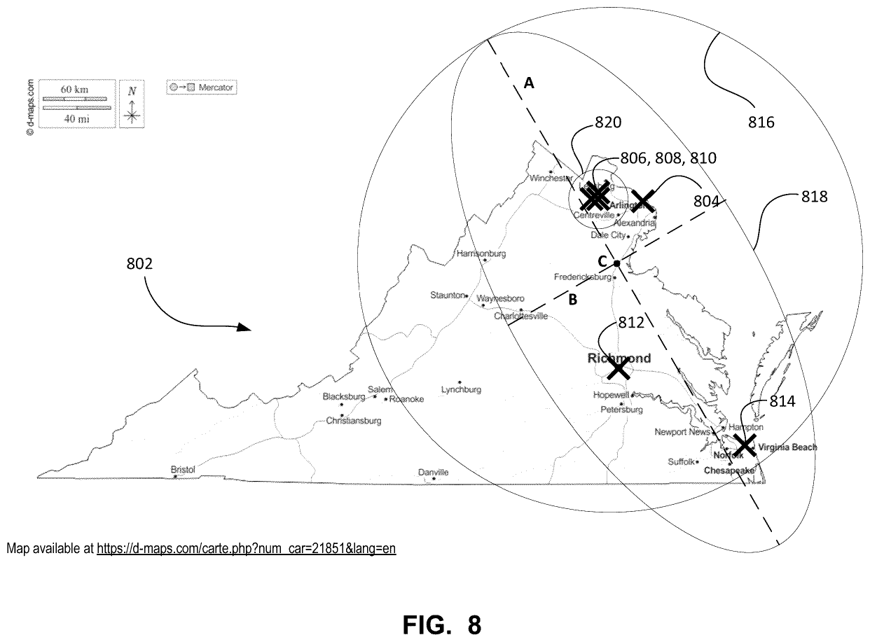

In some embodiments, the location parameter may be determined based on a distance between deposit locations of checks associated with the payee customer and/or common payer, as described in more detail with respect to FIG. 8. For example, in some embodiments, check assessment model 606 may determine that, on average, checks addressed to the payee customer and/or from the common payer are submitted for deposit within a defined geographical radius or perimeter. Variability may exist; for example, check assessment model 606 may determine that check 602b was submitted for deposit, as an example, within 20 miles of the location that check 602c was submitted for deposit. This distance is exemplary; check assessment model 606 may determine any geographical radius or perimeter describing the location of submission of checks addressed to the payee customer and/or from common payer.

In some embodiments, the location parameter may indicate an expected geographical area of submission and/or image capture of a check addressed to the payee customer and/or from the common payer. For example, the location parameter may be an area within which it is expected, based on past deposit patterns, that a single check addressed to the payee customer and/or from the common payer will be submitted for deposit. Example location parameters are discussed with respect to FIG. 8.

Alternatively, or in addition, the analysis performed by check assessment model 606 on the future check 602 may include whether a visual metadata value related to the future check 602 corresponds to a visual metadata parameter. In some embodiments, check assessment model 606 may determine one or more visual metadata parameters associated with a payee customer and/or a common payer. The one or more visual metadata parameters may be determined based on visual metadata included in metadata 604 (e.g., extracted by image-of-image detection program(s) 512). The one or more visual metadata parameters may be determined based on visual metadata associated with the payee customer, optionally for transactions with the common payer. For example, in some embodiments, check assessment model 606 may determine that, on average, checks addressed to the payee customer and/or from the common payer are associated with an image that has a brightness (including a normalized brightness) below a certain threshold. Likewise, in some embodiments, check assessment model 606 may determine that, on average, checks addressed to the payee customer and/or from the common payer are associated with an image that has a blue light level below a certain threshold. Likewise, in some embodiments, check assessment model 606 may determine that, on average, checks addressed to the payee customer and/or from the common payer have specific dot features or a single specific dot feature (if from the common payer alone). Variability may exist; for example, check assessment model 606 may determine that an image of check 602b has a brightness of X, while an image of check 602c has a brightness of Y that is greater than X.

In some embodiments, the one or more visual metadata parameters (e.g., related to brightness and blue light) may be associated with the payee customer alone. In some embodiments, the one or more visual metadata parameters (e.g., related to a dot feature) may be associated with a common payer alone. In some embodiments, the one or more visual metadata parameters (e.g., related to brightness, blue light, and a dot feature) may be associated with the payee customer and the common payer. This may be useful to account for the fact that checks from a particular common payer may have a certain hue/reflectivity that differs from checks of other common payers, thus affecting brightness and/or blue light levels.

In some embodiments, the one or more visual metadata parameters (e.g., related to brightness and blue light) may be further based on image capture location data. A typical GPS included in a mobile device can determine location data to an accuracy of under 5 meters, and this accuracy will continue to improve. Accordingly, image capture location may indicate typical lighting conditions at that location. For example, a payee customer may regularly conduct mobile deposits at a dining room table, which has a fixed location and largely standard lighting conditions. Accordingly, it may be determined that deposits conducted at that location are associated with typical brightness ranges and/or blue light level ranges. Check assessment model may determine the one or more visual metadata parameters (e.g., related to brightness and/or blue light) for various locations, such that if an image of a check for a deposit is captured at a location, a visual metadata parameter specific to that location may be applied in a comparison.

In some embodiments, the one or more visual metadata parameters (e.g., related to brightness and blue light) may indicate an expected range of brightness and/or blue light levels for an image of a check addressed to the customer. In some embodiments, the one or more visual metadata parameters (e.g., related to brightness and blue light) may indicate an expected range of brightness and/or blue light levels for an image of a check addressed to the customer and from the common payer. Alternatively, or in addition, the one or more visual metadata parameters (e.g., related to brightness and blue light) may indicate an expected range of brightness and/or blue light levels for an image of a check captured at a specific location. In some embodiments, the one or more visual metadata parameters may indicate image-of-image characteristics (e.g., brightness, blue light level, and/or dot feature) expected in a single check image provided by the payee customer, and/or associated with the common payer and/or a specific location.

In some embodiments, the location parameter and/or the one or more visual metadata parameters may be determined by check assessment model using statistical analysis. For example, the one or more visual metadata parameters (e.g., related to brightness and/or blue light) may be determined by calculating a mean brightness and/or blue light level of check images associated with deposit attempts by a payee customer and setting the one or more visual metadata parameters to include any brightness and/or blue light level value within one standard deviation (or within more standard deviations) of the mean brightness and/or blue light level. The location parameter may be determined as described with respect to FIG. 8. In some embodiments, the location parameter and/or the one or more visual metadata parameters may only be used once a predetermined threshold number of deposits have been used to determine the parameter(s). For example, in some embodiments, the predetermined threshold number may be 3, 5, 10, 20, 50, 100, or any appropriate number that ensures the parameter(s) are reasonably representative of past deposit patterns.

In some embodiments, the location parameter and/or the one or more visual metadata parameters may be determined only from previous deposit attempts that were successful (e.g., posed no or minimal security risk as determined by one or more security model(s) 412).

Once check assessment model 606 has determined one or more of the location parameter and the one or more visual metadata parameters associated with the payee customer, common payer, and/or image capture location, check assessment model 606 may compare metadata 604 associated with any future check 602 to the location parameter and/or one or more visual metadata parameters. For example, check assessment model 606 may compare location data associated with a check 602 (e.g., a deposit location) to the location parameter. Alternatively, or in addition, check assessment model 606 may compare one or more image-of-image characteristics to the one or more visual metadata parameters. Check assessment model 606 may determine a level of correspondence of the location data associated with the check 602 with the location parameter. Check assessment model 606 may determine a level of correspondence of the one or more image-of-image characteristics with the one or more visual metadata parameters. The level of correspondence of one or more of these comparisons may be represented in the form of a confidence score, as discussed in more detail with respect to FIG. 7.

In some embodiments, check assessment model 606 may provide the level of correspondence obtained from one or more of these comparisons either separately or collectively (e.g., in the form of one or more confidence scores), to an incident detection engine 608, which may determine whether the one or more confidence scores meet a predetermined threshold. By “meet” a predetermined threshold, it should be understood that the one or more confidence scores may be one or more scores indicating a likelihood a deposit attempt is legitimate, or may be one or more scores indicating a likelihood a deposit attempt is illegitimate. Accordingly, in the first case, “meeting” a predetermined threshold may include being below a predetermined threshold. In the second case, “meeting” a predetermined threshold may include exceeding a predetermined threshold. Both cases are contemplated. In both cases, the one or more confidence scores may be associated with whether a deposit attempt is illegitimate (e.g., fraudulent).

In response to incident detection engine 608 determining that the one or more confidence scores meet a predetermined threshold, incident detection engine 608 may determine that the a deposit attempt should be denied. In some embodiments, this determination may be provided to a payee customer in real-time as a remote deposit status 414. In response to incident detection engine 608 determining that the one or more confidence scores do not meet a predetermined threshold, incident detection engine 608 may determine that further assessment of the security of the deposit attempt is required. In some embodiments, this determination may also be provided to a payee customer in real-time as a remote deposit status 414. In such embodiments, the remote deposit status 414 may display to the payee customer a notification that the deposit attempt has been denied and in-person deposit is required, or that the deposit attempt has been accepted but the customer should retain the check for a few days. This may allow for a final security determination to be conducted, for example, at a backend server.

In some embodiments, check assessment model 606 and incident detection engine 608 may be implemented on client device 302, for example, as part of mobile banking app 304. In some embodiments, check assessment model 606 and incident detection engine may be implemented at cloud banking system 316 and/or at a third-party server. In both cases, metadata 604 may be provided to check assessment model 606 after being gathered by OCR program 508, ML OCR model 510, and/or image-of-image detection program(s) 512 that may each either be implemented at client device 302 or a backend system (e.g., cloud banking system 316 and/or a third party server). In both cases, in some embodiments, the results of check assessment model 606 and incident detection engine 608 may be output in real time (e.g., within a current customer transaction period before the payee customer submits a deposit request or immediately after in response to the payee customer submitting the deposit request). Alternatively, in some embodiments, the results of check assessment model 606 and incident detection engine 608 may be provided substantially after a payee customer submits a deposit request, for example, within a day of the deposit request submission. In some embodiments, check assessment model 606 and incident detection engine 608 may be implemented as part of a standard, non-real-time security assessment performed on a deposit request.

FIG. 7 illustrates an example flow diagram for processing a check 602. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 7, as will be understood by a person of ordinary skill in the art.

Check 602 in FIG. 7 may be any check that is being processed to determine the location parameter and/or the one or more visual metadata parameters based on metadata 604. Alternatively, or in addition, check 602 of FIG. 7 may be a check that is being processed to determine a level of correspondence of an image capture location 702 and/or deposit location 704 with the location parameter, or one or more image-of-image characteristics 706 with the one or more visual metadata parameters. In some embodiments, check 602 may be both. That is, data associated with check 602 (e.g., metadata 604) may be used to determine or refine the location parameter and/or the one or more visual metadata parameters, and the associated data may also be compared to data associated with previous checks to determine a level of correspondence as described above.

As shown in FIG. 7, data associated with check 602 may be in the form of metadata 604. In some embodiments, metadata 604 may include one or more of location data for an image of check 602 (e.g., image capture location 702 and/or deposit location 704), a MICR 703 of check 602, a payee 705 (identified via OCR and/or retrieved from customer account data), and image-of-image characteristics 706 for an image of check 602, which may include one or more of brightness 708; blue light 710; resolution feature 712 (including a binary determination on presence of absence of a resolution feature and/or an associated confidence score); moiré pattern 714 (including a binary determination on the presence or absence of a moiré pattern and/or an associated confidence score); and/or dot feature 716 (including a dot feature pattern, a binary determination on the presence of absence of two dot features, and/or an associated confidence score). As shown in FIG. 7, image-of-image characteristics 706 may include any other characteristics related to whether an image is an image of a printed or screen-displayed image.

In some embodiments, one or more images of check 602 may be stored in a DB 718. In alternative embodiments, no image of check may be stored in DB 718, but metadata 604 without an image may be stored. DB 718 may be any suitable form of database, such as a hierarchical database, a network database, an object-oriented database, a relational database, a cloud database, a centralized database, and/or a NoSQL database. In some embodiments, DB 718 may reside on cloud banking system 316, for example, as part of file DB 320. In some embodiments, DB 718 may reside on client device 302 as part of client device 302's internal storage. In some embodiments, metadata 604 may be stored in a metadata file, which may be linked to the image of check 602 and/or a deposit request and stored in DB 718. The metadata file may include one or more of the items indicated in FIG. 7.

As shown in FIG. 7, check assessment model 606 may communicate with DB 718 to retrieve and store data. For example, in some embodiments, check assessment model 606 may communicate with DB 718 to retrieve metadata associated with one or more check images, and may retrieve and store location parameters and/or visual metadata parameters determined by check assessment model 606 based on the metadata. In some embodiments, a portion of check assessment model 606 may determine the parameters based on data in DB 718 (which may be stored at cloud banking system 316 and/or a third party server) and may communicate the parameters to mobile banking app 304 (e.g., from a backend server). Then, another portion of check assessment model 606 operating within mobile banking app 304 may perform comparisons of metadata 604 (with or without storing the metadata 604 in DB 718) of future checks 602 with the parameters. Accordingly, in some embodiments, check assessment model 606 may be distributed across a backend server and mobile banking app 304.

In some embodiments, an image of a check 602 may be captured using camera 308 and processed using image processing system 310, and associated data fields and image-of-image characteristics (e.g., metadata 604) may be stored in DB 718. Check assessment model 606 may retrieve metadata 604 to compare it with past metadata associated with images of checks provided by the payee 705 and/or to determine a location parameter and/or one or more visual metadata parameters. In some embodiments, check assessment model 606 may retrieve metadata 604 of a check 602 from DB 718 in response to instructions from mobile banking app 304, which has initiated a mobile deposit of the check 602. In some embodiments, the instructions can include an identifier associated with check 602 and a location of metadata 604 associated with check 602 in DB 718.

In some embodiments, once check assessment model 606 retrieves metadata 604, check assessment model 606 may optionally determine, based on MICR 703, that check 602 is associated with a payer. Check assessment model 606 may then retrieve the location parameters and/or one or more visual metadata parameters associated with payee 705 and/or the payer. Check assessment model 606 may then compare image capture location 702 and/or deposit location 704 to the location parameter and/or one or more of image-of-image characteristics 706 to the one or more visual metadata parameters. Based on the comparison(s), check assessment model 606 may compute one or more confidence scores. In some embodiments, check assessment model 606 may compute a confidence score indicating a level of correspondence of image capture location 702 and/or deposit location 704 with the location parameter and one or more confidence scores indicating a level of correspondence of one or more image-of-image characteristics 706 with the one or more visual metadata parameters. In some embodiments, check assessment model 606 may compute a single confidence score indicating a level of correspondence of image capture location 702 and/or deposit location 704 with the location parameter and a level of correspondence of one or more image-of-image characteristics 706 with the one or more visual metadata parameters. In some embodiments, the multiple or single confidence scores may indicate a likelihood a check image is legitimate (e.g., not fraudulent). Alternatively or additionally, in some embodiments, the multiple or single confidence scores may indicate a likelihood a check image is illegitimate (e.g., fraudulent). Either way, the multiple or single confidence scores may be associated with whether the check image is illegitimate (e.g., fraudulent).

In some embodiments, for a given check 602 associated with a payee customer, check assessment model 606 may compute the one or more confidence scores based on one or more of the following non-limiting factors:
1. Whether deposit location 704 falls within the location parameter and/or the distance between deposit location 704 and the center point of the location parameter;
2. Whether an image-of-image characteristic 706 (e.g., brightness or blue light) falls within a visual metadata parameter and/or the difference between an image-of-image characteristic 706 and the center of the visual metadata parameter. As noted above, the visual metadata parameter related to brightness or blue light may be based on location data (e.g., may be associated with a past image capture location 702 that predicts what sort of lighting may be expected at that location). In some embodiments, the weighting associated with a comparison of brightness or blue light to a visual metadata parameter (W4 or W5) that is associated with a past image capture location 702 may be reduced or increased based on the distance between a current image capture location 702 and the past image capture location 702 with which the visual metadata parameter is associated;
3. Whether an image-of-image characteristic 706 (e.g., brightness or blue light) exceeds a predetermined threshold that is not based on past deposit data tracked by check assessment model 606. Excessive brightness and/or blue light may indicate an image is an image of a screen regardless of past deposit data tracked by check assessment model 606. In some embodiments, the predetermined threshold may be set within check assessment model based on known typical levels for brightness/blue light of a check image;
3. Whether an image-of-image characteristic 706 (e.g., resolution feature or moiré pattern) is present and/or a confidence score indicating the likelihood the image-of-image characteristic 706 is present;
4. Whether an image-of-image characteristic 706 (e.g., dot feature 716) matches an image-of-image characteristic 706 of a check 602 previously submitted by the payee customer, a confidence score indicating the likelihood the image-of-image characteristic 706 matches the previous image-of-image characteristic 706, and/or the number of previous image-of-image characteristics 706 that the image-of-image characteristic 706 matches;
5. Whether an image-of-image characteristic 706 (e.g., dot feature 716) matches an image-of-image characteristic 706 of a check 602 previously submitted by the payee customer and issued by a common payer, a confidence score indicating the likelihood the image-of-image characteristic 706 matches the previous image-of-image characteristic 706, and/or the number of previous image-of-image characteristics 706 that the image-of-image characteristic 706 matches of checks 602 issued by the common payer; and
6. Whether two image-of-image characteristics 706 (e.g., dot features 716) are present/a confidence score indicating the likelihood two image-of-image characteristics 706 are present; and
7. Whether the image capture location 702 matches the deposit location 704 and/or a distance between the image capture location 702 and the deposit location 704. By “matches,” it should be understood that some tolerance exists. For example, whether the image capture location 702 matches the deposit location 704 may be determined based on whether image capture location 702 is within a predetermined threshold distance of deposit location 704, where the predetermined threshold distance may be a typical error value for mobile GPS systems. Further, basing the one or more confidence scores on the distance between image capture location 702 and deposit location 704 may account for cases in which a payee customer captures a valid image but then moves to a different location with client device 302 before and/or at the time of submitting a deposit request.

In some embodiments, metadata 604 can optionally include time data. For example, in some embodiments, metadata 604 can include an image capture time (e.g., corresponding to an image capture location 702) and/or a deposit time (e.g., corresponding to a deposit location). In such embodiments, the image capture time and/or deposit time can be used by check assessment model 606 to determine time-dependent parameters and/or thresholds, which can be implemented in any of the factors affecting the one or more confidence scores enumerated above. For example, in some embodiments, check assessment model 606 can determine time-dependent location parameters that vary based on time of day, month, and/or year, depending on a payee customer's deposit location patterns at various times of day, month, and/or year. Likewise, in some embodiments, check assessment model 606 can determine time-dependent visual metadata parameters that vary based on time of day, month, and/or year, and may be indicative of typical lighting conditions at various times of day, month, and/or year. Accordingly, in some embodiments, a visual-metadata parameter used by check assessment model 606 in a comparison may be dependent on both location and time.

Additionally or alternatively, in some embodiments, check assessment model 606 can determine time-dependent thresholds (e.g., blue light or brightness thresholds) that vary based on time of day, month, and/or year, and may be indicative of typical lighting conditions at various times of day, month, and/or year.

In embodiments in which one or more parameters and/or thresholds are time-dependent, check assessment model 606 can determine and/or retrieve the one or more time-dependent parameters and/or thresholds for a comparison based on time data associated with a check 602 associated with a payee customer. The time data associated with the check 602 can be image capture time or deposit time, depending on the type of parameter. For example, when check assessment model 606 receives a given check 602 and/or associated metadata 604 for performing a comparison to a parameter, check assessment model 606 can retrieve a time-dependent location parameter based on the deposit time, the retrieved time-dependent location parameter corresponding to the deposit time. As another example, check assessment model 606 can retrieve a time-dependent visual metadata parameter based on the image capture time, the retrieved time-dependent visual metadata parameter corresponding to the image capture time.

Additionally or alternatively, in some embodiments, check assessment model 606 can assess whether the image capture time matches the deposit time and/or the difference between the image capture time and the deposit time. In such embodiments, the one or more confidence scores can be based on the result(s). By “matches,” it should be understood that some tolerance exists. For example, whether the image capture time matches the deposit time may be determined based on whether the image capture time is within a predetermined threshold time of the deposit time, where the predetermined threshold time can account for a typical time between capturing an image and submitting a deposit request within a mobile application (e.g., mobile banking app 304). Differences greater than the predetermined threshold time may indicate that an image was captured using a different device or is a previously submitted image, and the attempt to deposit a check 602 depicted in the image is fraudulent.

In some embodiments, if check assessment model 606 determines that the deposit time does not match the image capture time, check assessment model 606 can communicate this result to mobile banking app 304 (e.g., via one or more APIs). If mobile banking app 304 determines that the image was captured using mobile banking app 304 (i.e., was not obtained from another source, which may indicate jailbreaking/rooting of client device 302), mobile banking app 304 can display a message indicating the user's deposit request timed out.

In computing the one or more confidence scores, in some embodiments, check assessment model 606 may weight each item of metadata 604 equally. That is, the plurality of weights W1-W9 shown in FIG. 7 may be equal. In some embodiments, check assessment model 606 may weight some items of metadata 604 (e.g., image capture location 702 and deposit location 704) equally (W1=W3) and some items of metadata 604 (e.g., brightness 708 and moiré pattern 714) differently (W4/W8). In some embodiments, check assessment model 606 may group items of metadata (e.g., image-of-image characteristics 706) and weight the group equally or differently with other items of metadata (e.g., image capture location 702 and deposit location 704) (the sum of W4-W9=W1+W3). In some embodiments, check assessment model 606 may set one or more of weights W1-W9 to 0, such that an item of metadata 604 is not considered at all. For example, in some embodiments, check assessment model 606 may set weights W1 and W4-W9 to 0 such that only the level of correspondence of deposit location 704 to the location parameter is considered. Likewise, check assessment model 606 may set one or both of weights W1 and W3 to 0 such that only the level of correspondence of one or more image-of-image characteristics 706 to the one or more visual metadata parameters is considered. As an additional example, check assessment model 606 may set all of weights W1-W5 and W8-W9 equal to zero such that only the presence or absence of a resolution feature 712 and/or moiré pattern 714 (and/or associated confidence scores) is considered. In some embodiments, W2 may indicate an extent to which MICR 703 (and extracted payer data) is considered in a comparison to a parameter, which may effectively adjust the extent to which a value of metadata 604 is compared with parameters associated with a common payer vs. being compared to parameters associated with a payee 705 generally.

In some embodiments, check assessment model 606 may be configured to perform single validations, including one of the following:
1. Comparison of image capture location 702 to location parameter;
2. Comparison of deposit location 704 to location parameter;
3. Comparison of brightness 708 to visual metadata parameter related to brightness;
4. Comparison of blue light 710 to visual metadata parameter related to blue light;
5. Presence/absence of resolution feature 712;
6. Presence/absence of moiré pattern 714;
7. Comparison of dot feature 716 to past dot features 716;
8. Presence/absence of two dot features 716;
9. Comparison of image capture location 702 to deposit location 704; or
10. Comparison of image capture time to deposit time.

Check assessment model 606 may include operations for performing any one or any subset of the above validations, to the exclusion of operations for performing any one or any remaining subset of the above validations.

In some embodiments, check assessment model 606 may modify weights W1-W9 based on other items of metadata 604. For example, in some embodiments, based on the levels of correspondence of brightness 708, blue light 710, and/or a dot feature 716 with visual metadata parameters, and the absence of a resolution feature and moiré pattern, check assessment model 606 may reduce the weight of deposit location 704 (W3). This may be useful to identify and accommodate instances in which a check displays characteristics of a valid check, but is being deposited outside a normal deposit location pattern. Additionally, in some embodiments, weights of check assessment model 606 may be modified to account for payee customer location information, for example, provided by a payee customer. For example, W1 and/or W3 may be reduced or lowered to 0 based on information from the payee customer that the payee customer will be traveling during a certain time period.

In some embodiments, the one or more confidence scores determined by check assessment model 606 may indicate a likelihood that a check 602 is a counterfeit check (and/or a likelihood that the check is not a counterfeit check). For example, check assessment model 606 may determine a confidence score indicating a high level of correspondence of deposit location 704 with the location parameter, but receive a determination that a moiré pattern 714 is present (and/or a confidence score indicating a high likelihood a moiré pattern 714 is present). Such a result may indicate a high likelihood the check is counterfeit (e.g., an image of a check displayed on an electronic display).

In some embodiments, check assessment model 606 may weight one or more image-of-image characteristics 706 more highly in determining whether to flag a check as a potential counterfeit check. For example, moiré pattern 714 (W7) may be weighted more highly than other image-of-image characteristics 706, given that the presence of a moiré may be highly unusual for a non-fraudulent check. In some embodiments, weights W1-W9, and particularly weights W4-W9, may be set based on the output of a deep learning model which analyzes metadata 604 associated with counterfeit checks and determines an extent of association between an item of metadata 604 and whether a check is counterfeit. In such embodiments, the deep learning model may operate on ML platform 329 and have access to DB 718.

While FIG. 7 shows metadata 604 including image capture location 702, MICR 703, payee 705, deposit location 704, and image-of-image characteristics 706, in some embodiments, metadata may include image capture location 702, payee 705, and deposit location 704, without one or all of image-of-image characteristics 706. In some embodiments, for example, if DB 718 is specific to a single payee customer, no payee 705 field need be included. In some embodiments, the level of correspondence of a check 602 to deposit patterns may be determined based only on the level of correspondence of deposit location 704 to the location parameter and/or the level of correspondence of image capture location 702 and deposit location 704. In such embodiments, the one or more confidence scores may be computed based on one or more of the following non-limiting factors:
1. Whether deposit location 704 falls within the location parameter and/or the distance between deposit location 704 and the center point of the location parameter; and
2. Whether the image capture location 702 matches the deposit location 704 and/or a distance between the image capture location 702 and the deposit location 704.

In some embodiments, check assessment model 606 may implemented on one or more processors of client device 302, cloud banking system 316, or a third party platform. In some embodiments, check assessment model 606 may be implemented on an edge server within cloud banking system 316.

In some embodiments, check assessment model 606 be a rule-based algorithm. In some embodiments, check assessment model 606 may be a ML model. For example, in such embodiments, check assessment model 606 may be an ML model trained on metadata 604 and/or images of checks 602. In such embodiments, check assessment model may be trained using supervised learning, in which images of checks 602 that have been deposited by one or more customers may be provided to an untrained version of check assessment model 606 and may be labeled as fraudulent or not fraudulent. In some embodiments, the images of checks 602 may be provided to an untrained or partially trained check assessment model 606 with one or more items of metadata 604, and optionally location/visual metadata parameters as discussed herein for one or more customers. As a result, a ML check assessment model 606 may provide a confidence score indicating a likelihood a check 602 is not fraudulent (and/or a confidence score indicating a likelihood that the check 602 is fraudulent) in response to an image of check 602 and/or metadata 604 being provided to the ML check assessment model 606. In such embodiments, the ML check assessment model 606 may be trained on ML platform 329 and run on either ML platform 329 or client device 302.

FIG. 8 illustrates example location parameters 816, 818, 820, according to some embodiments. Operations described may be implemented by processing logic that may comprise hardware (e.g., circuitry, dedicated logic, programmable logic, microcode, etc.), software (e.g., instructions executing on a processing device), or a combination thereof. It is to be appreciated that not all operations may be needed to perform the disclosure provided herein. Further, some of the operations may be performed simultaneously, or in a different order than described for FIG. 8, as will be understood by a person of ordinary skill in the art.

As shown in FIG. 8 check assessment model 606 may track location data for various deposits. The deposits may include a first deposit 804, second, third, and fourth deposits 806, 808, 810, a fifth deposit 812, and a sixth deposit 814. In some embodiments, the location data for each of the deposits may include deposit location 704. In some embodiments, the location data for each of the deposits may include image capture location 702. In some embodiments, the location data for each of the deposits may include both image capture location 702 and deposit location 704. The location data may be derived from GPS 514 and/or a GPS of another device if the deposit is illegitimate, as discussed with respect to FIG. 5. As noted above, “deposit location” may refer to the location of client device 302 at the time the payee customer is interacting with mobile banking app 304 to submit a deposit. Accordingly, “deposit location” may be the location of client device 302 before or immediately after the payee customer submits a deposit request.

FIG. 8 shows various embodiments of location parameters. While location parameters are shown on a map that depicts a geographical area 802, it should be understood that check assessment model 606 need not maintain a visual map, and the location parameters may be defined based on distances from one or more previous deposit locations as calculated from GPS data (e.g., latitude and longitude). In determining location parameters, check assessment model 606 and/or mobile banking app 304 may convert latitude and longitude (or whatever units are provided when using GPS 514) into distances from deposit location(s) and/or a geographical center point C that may be expressed in any distance unit (e.g., miles, km, meters, feet, inches, cm, etc.).

In some embodiments, a first location parameter 816 may be calculated as perimeter around the geographic center point C of a group of deposit locations, each point on the perimeter being equidistant from the center point. In some embodiments, the radius of the first location parameter 816 may be determined based on the concentration of deposit locations; the closer the deposit locations are to one another, the smaller the radius. In some embodiments, the radius of the first location parameter 816 may be a predefined distance set by the bank implementing cloud banking system 316 and mobile banking app 304, where the radius is at least large enough so that the first location parameter 816 includes all the data points.

In some embodiments, first location parameter 816 may be associated with a payee customer, without being associated with a common payer (i.e., deposits 804-814 are associated with different payers).

In some embodiments, a second location parameter 818 may be calculated as perimeter around the geographic center point C of a group of deposit locations, but each point on the perimeter need not be equidistant from the center point C. In such embodiments, the distance of points on the perimeter to the geographic center point C may vary around the circumference of the perimeter. The distance of points on the perimeter to the geographic centerline may be inversely proportional to a concentration of deposit locations along an axis that passes from one point on the perimeter, through the geographic center point C, and to an opposing point on the perimeter (e.g., axis A). For example, as shown in FIG. 8, the coordinates of deposits 804-814 as measured with respect to axis B are much more concentrated than the coordinates of deposits 804-814 as measured with respect to axis A. As a result, second location parameter 818 is longer along axis A than it is along axis B. Accordingly, the second location parameter 818 may better describe expected locations of future deposit attempts.

While FIG. 8 shows second location parameter 818 as an approximate ellipse, irregular (and potentially more accurate) shapes may be obtained by calculating the distance center point C for a given point on the perimeter at more than four points (i.e., using more axes), and connecting the given points.

While the distance of points on the perimeter of second location parameter 818 to the geographic centerline may be inversely proportional to a concentration of deposit locations along an axis that passes from one point on the perimeter, through the geographic center point C, and to an opposing point on the perimeter, a scaling factor may be used to ensure that the perimeter of the second location parameter 818 is outside of all deposit locations being considered in determining second location parameter 818.

In some embodiments, a third location parameter 820 may be determined as described for first or second location parameters 816, 818. However, the third location parameter 820 may be associated with a payee customer and a common payer. For example, deposits 806, 808, 810 may be deposits of checks issued by a common payer. Accordingly, the third location parameter 820 accounts not just for payee deposit location history, but payee deposit location history that is specific to a certain payer. This may be useful to 1) provide a location parameter that is more strict, as a payee customer is more likely to deposit checks from a common payer within a smaller geographic area, and/or 2) provide a location parameter that is more resilient against false identification of illegitimate deposit activity. Regarding this second point, a common payer-specific location parameter may prevent instances of flagging as illegitimate instances of depositing a check outside an expected geographic region, as the behavior may be less suspicious since the check has not been issued by any payer associated with previously submitted deposits. In such cases, the payee may have received and deposited a check while traveling outside of a common geographic region.

Alternatively or in addition to the methods described above for determining a location parameter, assessment model 606 may consider payer location data in determining a location parameter. The payer location data may be obtained using OCR (e.g., may be payer address 204) and/or may be obtained from MICR 703. In the second option, account number information from MICR 703 may be used to obtain an address of the payer either from online records or a database. In some cases, the payer may also be a customer of the bank implementing cloud banking system 316 and mobile banking app 304 such that the payer's address is readily available to check assessment model 606. Basing a location parameter on payer location data may help identify suspicious activity such as depositing a check far from a payer address. For some types of checks (e.g., government checks), this feature may be turned off, as it is expected that such types of checks have been mailed to a payee customer.

While three location parameters 816, 818, and 820 have been described, any form or number of location parameters may be implemented. Location parameters 816, 818, and 820 are example location parameters that may be used alternatively or simultaneously for assessing a given deposit attempt. For example, in some embodiments, first location parameter 816 OR second location parameter 818 may be implemented, along with third location parameter 820, for comparison to location data for a given deposit attempt. In some embodiments, only first location parameter 816 OR second location parameter 818 may be implemented. In some embodiments, only third location parameter 820 may be implemented. When a non-common-payer-specific location parameter and a common-payer-specific location parameter are implemented together, the one or more confidence scores output by check assessment model 606 may depend on comparisons of location data for a given deposit attempt to both of the location parameters.

In some embodiments, the one or more confidence scores output by check assessment model 606 may depend on one or more of the following factors: 1) whether location data for a given deposit attempt (e.g., image capture location 702 or deposit location 704) indicates the deposit attempt is occurring outside a location parameter; 2) the distance from center point C at which a deposit attempt is occurring; and 3) the distance from center point C at which a deposit attempt is occurring, scaled according to a concentration of previous deposit attempts as measured along an axis that passes through center point C and the point at which the deposit attempt is occurring.

While the above methods have been described as example methods, any method may be used for assessing how far, geographically, a deposit attempt is occurring from past deposit activity. Accordingly, comparison to a location parameter is not limited to any of the specific examples described above, but may be performed in any way that relates a confidence score associated with whether a deposit attempt is illegitimate to a comparison of a current deposit location and the location(s) of past deposit attempts.

In some embodiments, the determination of location parameters 816, 818, and/or 820 may exclude deposit locations for deposit attempts that were previously denied. In some embodiments, the calculation of location parameters 816, 818, and/or 820 may exclude deposit locations for deposit attempts that were previously denied, but only if they were not later successfully completed at physical location. In some embodiments, check assessment model 606 may continually refine one or more location parameters based on new deposit attempts. In some embodiments, the one or more location parameters may be deployed for comparisons at defined intervals of numbers of deposit attempts upon which the one or more location parameters are based. For example, a location parameter may be deployed after 10 deposit attempts have been analyzed to determine the location parameter, refined in the background, and then deployed again after 20 deposit attempts, etc., in any interval pattern.

While the determination of location parameters 816, 818, 820 as discussed above used deposit locations, in some embodiments, image capture locations may be used. In such embodiments, comparison to a location parameter may be performed using image capture location for a given deposit attempt.

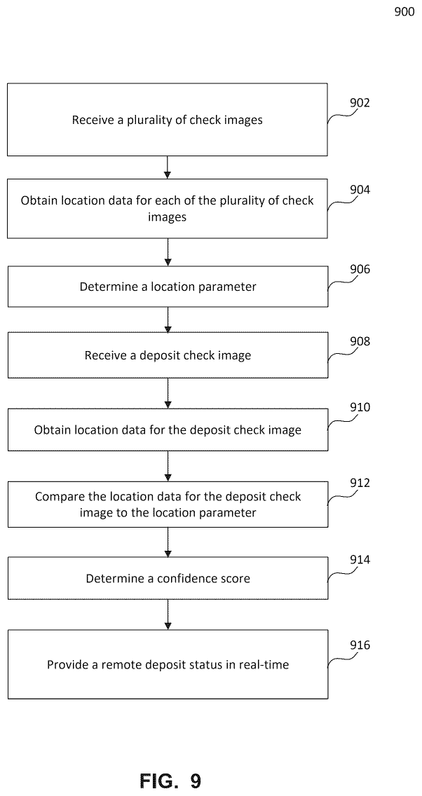

FIG. 9 is a flow chart depicting a check assessment method 900 that may be carried out in line with the discussion above. One or more of the operations in the method depicted by FIG. 9 could be carried out by one or more entities, including, without limitation, validation module 326, ML platform 329, client device 302, or other server or cloud-based server processing systems and/or one or more entities operating on behalf of or in cooperation with these or other entities. Any such entity could embody a computing system, such as a programmed processing unit or the like, configured to carry out one or more of the method operations. Further, a non-transitory data storage (e.g., disc storage, flash storage, or other computer readable medium) could have stored thereon instructions executable by a processing unit to carry out the various depicted operations. In some embodiments, the systems described generate may assess a deposit attempt to determine whether the deposit attempt is legitimate.

Unless stated otherwise, the steps of method 900 need not be performed in the order set forth herein. Additionally, unless specified otherwise, the steps of method 900 need not be performed sequentially. The steps may be performed in a different order or simultaneously. As one example, step 906 of method 900 need not be performed before step 908. Rather, step 908 may be performed simultaneously with or before step 906. Further, method 900 need not include all the steps illustrated. For example, in some embodiments, method 900 need not include steps 904-906 and 910-912. Instead, in some embodiments, method 900 may include steps related to assessing correspondence with a visual metadata parameter and/or assessing whether an image-of-image characteristic (e.g., a moiré pattern) is present in an image.

Step 902 may include receiving a plurality of check images. In some embodiments, each of the plurality of check images may include an image of a check (e.g., a check 602) obtained using a mobile device associated with a user (e.g., mobile computing device 102/client device 302 associated with a payee customer).

Step 904 may include obtaining location data (e.g., image capture location 702 and/or deposit location 704) for each of the plurality of check images. In some embodiments, the location data for each of the plurality of check images may include at least one of image capture location data (e.g., image capture location 702) or deposit location data (e.g., deposit location 704). In some embodiments, the deposit location data includes a location of the mobile device at a time the user is interacting with a mobile banking app to submit a deposit.

Step 906 may include determining a location parameter (e.g., location parameter 816, 818, or 820). In some embodiments, the location parameter may be associated with the user. In some embodiments, the location parameter may be determined based on the location data for one or more of the plurality of check images. In some embodiments, the determining the location parameter of step 906 may include calculating the location parameter based on location data for more than one of the plurality of check images, such that the location parameter represents a mobile deposit location pattern. In some embodiments, the location parameter may be determined based on the image capture location data. In some embodiments, the location parameter may be determined based on the deposit location data.

Step 908 may include receiving a deposit check (e.g., another check 602) image. In some embodiments, the deposit check image may be provided by the user. In some embodiments, the deposit check image may be submitted by the user. In some embodiments, the deposit image may be in the process of being assessed at client device 302, but may not have yet been or will never be submitted by the user (i.e., due to all image processing being conducted at client device 302).

Step 910 may include obtaining location data (e.g., image capture location 702 and/or deposit location 704 of the check 602) for the deposit check image.

Step 912 may include comparing the location data for the deposit check image to the location parameter.

Step 914 may include determining a confidence score (a confidence score determined by check assessment model 606). In some embodiments, the confidence score may be determined based on the comparison of the location data for the deposit check image to the location parameter. In some embodiments, the confidence score may be associated with whether the deposit check image is fraudulent.

Step 916 may include providing a remote deposit status (e.g., remote deposit status 414) in real-time. In some embodiments, the remote deposit status may be related to acceptance of the deposit check image. In some embodiments, the remote deposit status may be provided via a display (e.g., client device display 506) of the mobile device.

In some embodiments, method 900 may include identifying, from the plurality of check images, one or more check images associated with a common payer (e.g., using MICR 703). In some embodiments, method 900 may include determining the location parameter based on the location data for the one or more check images associated with the common payer such that the location parameter is further associated with the common payer. In some embodiments, method 900 may include determining whether the deposit check image is associated with the common payer before comparing the location data for the deposit check image to the location parameter.

In some embodiments of method 900, the location data for the deposit check image may include image capture location data (e.g., image capture location 702) and deposit location data (e.g., deposit location 704). In some embodiments, method 900 may include comparing the image capture location data to the deposit location data. In some embodiments, method 900 may include, in response to the image capture location data not matching the deposit location data, determining the deposit check image is fraudulent. In some embodiments, in response to the image capture location data not matching the deposit location data, the deposit check image may be flagged for further review by a remote deposit specialist before determining that the deposit check image is fraudulent. In some embodiments, the confidence score may be based on whether the image capture location data and deposit location data match. In some embodiments, the confidence score may additionally or alternatively be based on a distance between the image capture location data and deposit location data.

In some embodiments, method 900 may include sending, in response to the confidence score meeting a predetermined threshold, a message to a payer (e.g., identified from MICR 703) associated with the deposit check image. In some embodiments, the message may be sent via remote deposit platform 410 using validation module 326. In some embodiments, the message may include a request to verify the check depicted in the deposit check image. In some embodiments, the message may be a text message. In some embodiments, the message may be an email. In some embodiments, the payer may be a payer that is a customer of the bank implementing cloud banking system 316 and mobile banking app 304. Accordingly, the payer customer's contact information may have been identified from profile module 324 and/or a customer account 408. In some embodiments, the payer need not be a customer of the bank. In such embodiments, the payer's contact information may have been identified from OCR processing to obtain a phone number of field 204 as shown in FIG. 2. In some embodiments, the payer may review the deposit check image and determine whether the payer issued the check depicted in the image, and may provide a return message confirming or disconfirming the validity of the check.

In some embodiments, method 900 may include reading, using optical character recognition (OCR), a payee (e.g., payee 705) name depicted in the deposit check image. In some embodiments, method 900 may include comparing the payee name to a stored payee name (e.g., stored at account identification 314, customer account 408, and/or profile module 324). In some embodiments, method 900 may include, in response to the payee name not matching the stored payee name, determining the deposit check image is fraudulent and/or modifying a confidence score associated with whether the deposit check image is fraudulent. In some embodiments, in response to the payee name not matching the stored payee name, the deposit check image may be flagged for further review by a remote deposit specialist before determining that the deposit check image is fraudulent.

In some embodiments, method 900 may include reading, using OCR, an amount (e.g., amount 212 and/or written amount 214) depicted in the deposit check image and a MICR line (e.g., MICR line 220, MICR 703) depicted in the deposit check image. In some embodiments, method 900 may include identifying a payer associated with the deposit check image using the MICR line. In some embodiments, method 900 may include comparing the payee name and the amount to a list of payee names and corresponding amounts, the list having been communicated by the payer. In some embodiments, method 900 may include, in response to the payee name and the amount not matching a payee name and corresponding amount of the list, determining the deposit check image is fraudulent and/or modifying a confidence score associated with whether the deposit check image is fraudulent. In some embodiments, in response to the payee name and the amount not matching a payee name and corresponding amount of the list, the deposit check image may be flagged for further review by a remote deposit specialist before determining that the deposit check image is fraudulent.

In some embodiments, the list may have been communicated by a payer customer (the payer) to cloud banking system 316 upon issuing a plurality of checks. In some embodiments, the plurality of checks, associated payee names, and associated amounts may be provided in the list. In some embodiments, a bank implementing cloud banking system 316 and mobile banking app 304 may require certain customers (e.g., business customers) to provide such a list upon issuing checks.

In some embodiments, method 900 may include obtaining visual metadata (e.g., one or more image-of-image characteristics 706) related to at least one of brightness (e.g., brightness 708) or blue light (e.g., blue light 710) for each of the plurality of check images. In some embodiments, method 900 may include determining one or more visual metadata parameters associated with the user based on the visual metadata and the image capture location data for one or more of the plurality of check images. In some embodiments, the determining the one or more visual metadata parameters may include calculating one or more visual metadata ranges based on the visual metadata and the image capture location data for more than one of the plurality of check images, such that the one or more visual metadata ranges represent a mobile deposit visual metadata pattern. In some embodiments, method 900 may include obtaining deposit visual metadata (e.g., one or more image-of-image characteristics 706 associated with the other check 602) related to at least one of brightness (e.g., brightness 708 associated with the other check 602) or blue light (e.g., blue light 710 associated with the other check 602) for the deposit check image. In some embodiments, method 900 may include comparing the deposit visual metadata to the one or more visual metadata parameters. In some embodiments, the confidence score may be further based on the comparison of the deposit visual metadata to the one or more visual metadata parameters.

In some embodiments, method 900 may include determining the deposit visual metadata related to blue light based on pixel data including an RGB code, a YCbCr code, a HEX color code, a CMYK code, an HSL code, or an HSB code.

The solutions described above improve upon current remote deposit processes. The various embodiments solve at least the technical problem of assessing the legitimacy of a deposit attempt, optionally in real-time. In some embodiments, the legitimacy of the deposit attempt may be assessed without substantial processing by a computationally intensive model (e.g., a backend ML model) that considers manifold features of a customer's past deposit history. Instead, the various embodiments described herein may provide a means of quickly and easily identifying whether a deposit check corresponds to legitimate (e.g., non-fraudulent) deposit activity, such that additional processing may be avoided and/or a remote deposit status may be returned to a customer in real time. This may reduce processing complexity and more efficiently utilize the limited system resources of remote deposit system 300.

Further, the various embodiments described herein may provide means of more accurately identifying counterfeit checks, based on lack of correspondence to past checks and/or characteristics that indicate a check image is an image of an image. The various embodiments described herein may overcome the technical problems banks (or other institutions) face in detecting illegitimate (e.g., fraudulent) transactions when a physical check is not available for inspection by the bank. For example, the various embodiments described herein may overcome the difficulties banks face in remotely identifying certain features, for example, unusual thickness, pliability, presence or lack of edge features (e.g., serrations from a tear line), lack of magnetic ink within a MICR line, etc., that would indicate a check is counterfeit. Additionally, it may be difficult for computer systems to identify a counterfeit check when the check image is a digitally created image, since the image may have been created from an image of a real check (e.g., a past deposit) with certain features altered. However, the various embodiments described herein provide a means for analyzing digital images to identify attempts to deposit an image of an image.

While the above disclosure uses a check (e.g., check 602) as an example financial instrument, various embodiments discussed herein may apply to any type of financial instrument (e.g., money orders). Accordingly, the scope of this disclosure should not be limited to the remote deposit of a check alone. Additionally, the embodiments disclosed herein may be implemented with any type of document (e.g., an identification document such as a passport, license, social security card, birth certificate, student card, etc.). For example, the terms “check,” “deposit check,” and “remote deposit status” as used herein may be replaced with “document,” “submission document,” and “image acceptance status,” respectively, to describe embodiments implemented with any digital document verification process. In some embodiments not implemented for remote mobile check deposit, image-of-image characteristics determined using image-of-image detection program(s) may be considered, but no location data need be considered. In some embodiments not implemented for remote deposit, location data alone may be considered without image-of-image characteristics. And in some embodiments not implemented for remote deposit, both location data and image-of-image characteristics may be considered.

Considering location data may be particularly useful for identifying when a fraudulent user is attempting to submit an image of a valid document, but the document is owned by another individual. For example, the submission of an image of a valid identification document of another individual may normally grant the fraudulent user access to the individual's information, funds, etc. But the determination that the submission of the image is occurring outside a location parameter associated with the individual may be used to deny access to the fraudulent user, since it may reveal that the fraudulent user has obtained the image in an unauthorized manner.

Additionally, while an image “capture” or image “upload” has been described occasionally, in some embodiments, the methods discussed herein may be conducted without ever storing an image in permanent memory (e.g., image capture may simply refer to gathering pixel data) and/or without uploading an image to a backend system. For example, in some embodiments, the methods described herein may be performed using an OCR program and/or ML OCR model and image-of-image detection program(s) that operate exclusively at a client device, such that the assessment of metadata (e.g., metadata 604) associated with a check may be conducted without an image every being stored in permanent memory and/or uploaded to a backend system.

### Example Computer System

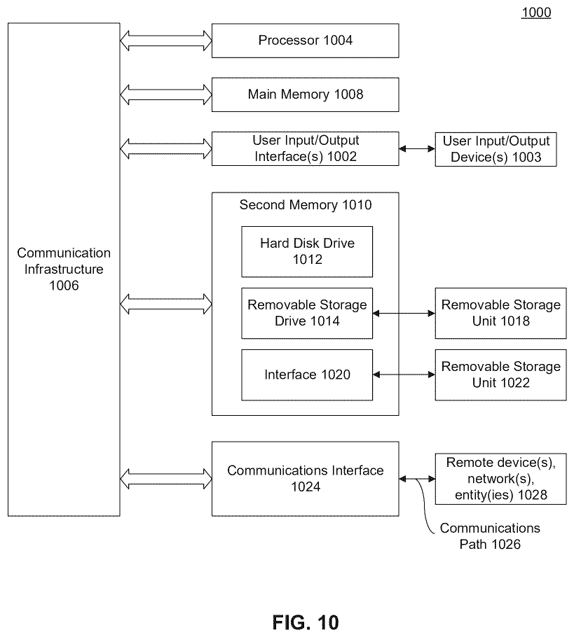

FIG. 10 depicts an example computer system useful for implementing various embodiments. For example, the example computer system may be implemented as part of mobile computing device 102 or cloud banking system 316. Cloud implementations may include a plurality of the example computer systems locally or distributed across one or more server sites.

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof.

Computer system 1000 may include one or more processors (e.g., a central processing unit, or CPU), such as processor(s) 1004. In some embodiments, for example, when machine learning models are implemented on client device 302, processor(s) 1004 may include a neural processing unit (NPU) and/or a tensor processing unit (TPU). One or more of processor(s) 1004 may be connected to a communication infrastructure or bus 1006.

Computer system 1000 may also include customer input/output device(s) 1003, such as monitors, keyboards, pointing devices, etc., which may communicate with communication infrastructure 1006 through customer input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 1018. Removable storage unit 1018 may include a computer usable or readable storage device having stored thereon computer software (control logic) and/or data. Removable storage unit 1018 may be a floppy disk, magnetic tape, compact disk, DVD, optical storage disk, and/any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 1024 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 900 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML Customer Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present disclosure as contemplated by the inventor(s), and thus, are not intended to limit the present disclosure and the appended claims in any way.

The present disclosure has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the disclosure that others can, by applying knowledge within the skill of the art, readily modify and/or adapt for various applications such specific embodiments, without undue experimentation, without departing from the general concept of the present disclosure. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present disclosure should not be limited by any of the above-described exemplary embodiments, but should be defined only in accordance with the following claims and their equivalents.

What is claimed is:

1. A computer-implemented method for a remote deposit environment, comprising:
receiving a plurality of check images, each of the plurality of check images comprising an image of a check obtained using a mobile device associated with a user,
obtaining location data for each of the plurality of check images;
determining a location parameter associated with the user based on the location data for one or more of the plurality of check images;
receiving a deposit check image provided by the user;
obtaining location data for the deposit check image;
comparing the location data for the deposit check image to the location parameter;
based on the comparison of the location data for the deposit check image to the location parameter, determining a confidence score associated with whether the deposit check image is fraudulent; and
providing, via a display of the mobile device, a remote deposit status related to acceptance of the deposit check image in real-time.

2. The method of claim 1, further comprising:
identifying, from the plurality of check images, one or more check images associated with a common payer; and
determining the location parameter based on the location data for the one or more check images associated with the common payer such that the location parameter is further associated with the common payer; and
determining whether the deposit check image is associated with the common payer before comparing the location data for the deposit check image to the location parameter.

3. The method of claim 1, wherein determining the location parameter comprises calculating the location parameter based on location data for more than one of the plurality of check images, such that the location parameter represents a mobile deposit location pattern.

4. The method of claim 1, wherein the location data for each of the plurality of check images comprises at least one of image capture location data or deposit location data.

5. The method of claim 3, wherein the location parameter is determined based on the image capture location data.

6. The method of claim 3, wherein the location parameter is determined based on the deposit location data.

7. The method of claim 1, wherein the location data for the deposit check image comprises image capture location data and deposit location data.

8. The method of claim 7, further comprising:
comparing the image capture location data to the deposit location data; and
in response to the image capture location data not matching the deposit location data, determining the deposit check image is fraudulent.

9. The method of claim 8, wherein the deposit location data comprises a location of the mobile device at a time the user is interacting with a mobile banking app to submit a deposit.

10. The method of claim 1, further comprising sending, in response to the confidence score meeting a predetermined threshold, a message to a payer associated with the deposit check image.

11. The method of claim 10, wherein the message comprises a request to verify the check depicted in the deposit check image.

12. The method of claim 1, further comprising reading, using optical character recognition (OCR), a payee name depicted in the deposit check image.

13. The method of claim 12, further comprising:
comparing the payee name to a stored payee name; and
in response to the payee name not matching the stored payee name, determining the deposit check image is fraudulent.

14. The method of claim 12, further comprising reading, using OCR, an amount depicted in the deposit check image and a MICR line depicted in the deposit check image.

15. The method of claim 14, further comprising:
identifying a payer associated with the deposit check image using the MICR line;
comparing the payee name and the amount to a list of payee names and corresponding amounts, the list having been communicated by the payer; and
in response to the payee name and the amount not matching a payee name and corresponding amount of the list, determining the deposit check image is fraudulent.

16. The method of claim 4, further comprising:
obtaining visual metadata related to at least one of brightness or blue light for each of the plurality of check images;
determining one or more visual metadata parameters associated with the user based on the visual metadata and the image capture location data for one or more of the plurality of check images;
obtaining deposit visual metadata related to at least one of brightness or blue light for the deposit check image; and
comparing the deposit visual metadata to the one or more visual metadata parameters;
wherein the confidence score is further based on the comparison of the deposit visual metadata to the one or more visual metadata parameters.

17. The method of claim 16, wherein determining the one or more visual metadata parameters comprises calculating one or more visual metadata ranges based on the visual metadata and the image capture location data for more than one of the plurality of check images, such that the one or more visual metadata ranges represent a mobile deposit visual metadata pattern.

18. The method of claim 16, further comprising determining the deposit visual metadata related to blue light based on pixel data including an RGB code, a YCbCr code, a HEX color code, a CMYK code, an HSL code, or an HSB code.

19. A system, comprising:
a memory; and
at least one processor coupled to the memory and configured to:
receive a plurality of check images, each of the plurality of check images comprising an image of a check obtained using a mobile device associated with a user,
obtain location data for each of the plurality of check images;
determine a location parameter associated with the user based on the location data for one or more of the plurality of check images;
receive a deposit check image provided by the user;
obtain location data for the deposit check image;
compare the location data for the deposit check image to the location parameter;
based on the comparison of the location data for the deposit check image to the location parameter, determine a confidence score associated with whether the deposit check image is fraudulent; and
provide, via a display of the mobile device, a remote deposit status related to acceptance of the deposit check image in real-time.

20. A non-transitory computer-readable device having instructions stored thereon that, when executed by at least one computing device, causes the at least one computing device to perform operations comprising:
receiving a plurality of check images, each of the plurality of check images comprising an image of a check obtained using a mobile device associated with a user,
obtaining location data for each of the plurality of check images;
determining a location parameter associated with the user based on the location data for one or more of the plurality of check images;
receiving a deposit check image provided by the user;
obtaining location data for the deposit check image;
comparing the location data for the deposit check image to the location parameter;
based on the comparison of the location data for the deposit check image to the location parameter, determining a confidence score associated with whether the deposit check image is fraudulent; and
providing, via a display of the mobile device, a remote deposit status related to acceptance of the deposit check image in real-time.
